(19) United States
(12) Patent Application Publication
(10) Pub. No.: US 2026/0160281 A1
(43) Pub. Date: Jun. 11, 2026

(54) MECHANISMS FOR DAMAGE DETECTION AND AUTONOMOUS REPAIR OF PUNCTURE DAMAGE FOR SELF-HEALING ARTIFICIAL MUSCLES

(71) Applicant: NUtech Ventures, Lincoln, NE (US)

(72) Inventors: Ethan J. Krings, Lincoln, NE (US); Patrick McManigal, Lincoln, NE (US); Eric J. Markvicka, Lincoln, NE (US)

(21) Appl. No.: 19/416,433

(22) Filed: Dec. 11, 2025

Related U.S. Application Data
(60) Provisional application No. 63/730,871, filed on Dec. 11, 2024.

(51) Int. Cl. F15B 20/00; B29C 73/34; F15B 15/10; F15B 19/00; G01M 3/16

(52) U.S. Cl. CPC F15B 20/005; F15B 15/103; F15B 19/005; B29C 73/34; F15B 2215/305; G01M 3/16

(57) ABSTRACT

An actuator may enable detecting the formation of electrical networks in a liquid metal-elastomer layer. Upon detecting the formation of the electrical networks, the actuator may initiate an autonomous repair process through in situ reprocessing, where Joule heating is used to trigger a self-healing material layer. Following the self-healing, the electrical networks may be is reconfigured. Self-healing the punctures and reconfiguring the electrical networks may restore functionality to the actuator without the need for external intervention. The integration of these features enhances the resilience of the actuator and mimics the adaptive capabilities found in biological systems, ultimately leading to more reliable and efficient performance in dynamic environments.

### CROSS-REFERENCE

The present application claims the benefit under 35 U.S.C. § 119 of U.S. Provisional application 63/730,871, filed on Dec. 11, 2024, titled “Mechanisms for Damage Detection and Autonomous Repair of Puncture Damage for Self-Healing Artificial Muscles,” which is incorporated herein by reference in the entirety.

### GOVERNMENT LICENSE RIGHTS

This invention was made with government support under Contract Number CMMI-2339780 awarded by the National Science Foundation. The government has certain rights in the “invention.”

### TECHNICAL FIELD

The present invention generally relates to gripping heads and other end effectors, and more specifically to gripper surfaces activated by a fluid.

### BACKGROUND

Soft robotics are characterized by their high deformability, mechanical robustness, and inherent resistance to damage. These unique properties present exciting new opportunities to enhance both emerging and existing fields such as healthcare, manufacturing, and exploration. However, to function effectively in unstructured environments, these technologies must be able to withstand the same real-world conditions to which human skin and other soft biological materials are typically subjected.

Soft materials with sensing, actuation, and self-healing capabilities are enabling a new generation of multifunctional technologies for applications ranging from bio-inspired soft robotics to wearable computing. These materials are highly deformable, mechanically robust, and naturally damage resistant and can withstand compressive forces, impacts, and bending that would typically damage rigid counterparts of similar size and weight. However, as soft-matter technologies transition from controlled laboratories to real-world environments, these materials must be able to endure the same conditions faced by human skin and other soft biological materials. To achieve this, these materials should have the ability to detect and respond to external stimuli, communicate damage information, and include self-healing mechanisms mimicking the remarkable adaptive resilience of living organisms. Incorporating these biomimetic functionalities is essential for ensuring the longevity of soft robotic and wearable systems as they interact with unpredictable real-world environments.

Human nervous tissue serves as an exemplary model of a soft, responsive material capable of detecting, communicating, and recovering from injuries through its inherent plasticity. This characteristic is particularly relevant for soft robotics designed for agricultural applications, which are often exposed to sharp objects such as twigs, thorns, plastic, or glass that can cause damage to these systems. To address this vulnerability, numerous studies have explored self-healing polymeric and elastomeric materials for soft robotics applications that employ a variety of mechanisms to achieve self-repair. These advancements have led to the development of soft systems with self-healing capabilities in sensors, electrical wiring, and actuation. Despite these promising developments, the comprehensive integration of damage detection, communication, and recovery through self-healing in soft-robotic technologies remains a significant challenge.

To enable reconfigurability, researchers have created liquid metal (LM) composites using physically cross-linked polymers. Unlike conventional covalent networks, these materials can be reprocessed with solvents to reconfigure the previously formed electrical networks. Previous studies have investigated the conductivity, electromechanical properties, and electrical response to damage of LM-elastomer composites. However, the previous studies require the manual repair of the polymers.

Therefore, it would be advantageous to provide a device, system, and method that cures the shortcomings described above.

### SUMMARY

An actuator is described, in accordance with one or more aspects of the present disclosure. In some aspects, the actuator may include an actuation layer defining one or more bladders. In some aspects, the actuation layer is extensible by inflation of the one or more bladders. In some aspects, the actuator may include a thermoplastic elastomer layer. In some aspects, the actuator may include a damage detection layer. In some aspects, at least one of the thermoplastic elastomer layer or the damage detection layer is inextensible such that the actuator is configured to actuate with the inflation of the one or more bladders. In some aspects, the damage detection layer includes a liquid metal-elastomer composite. In some aspects, the liquid metal-elastomer composite includes an elastomer medium, a plurality of liquid metal microdroplets, and a plurality of traces. In some aspects, the plurality of liquid metal microdroplets are dispersed within the elastomer medium. In some aspects, the plurality of traces are embedded within the elastomer medium. In some aspects, the elastomer medium is a dielectric. In some aspects, the plurality of liquid metal microdroplets and the plurality of traces are conductive.

A system is described, in accordance with one or more aspects of the present disclosure. In some aspects, the system may include the actuator. In some aspects, the actuator is configured to receive a puncture through the damage detection layer and the thermoplastic elastomer layer. In some aspects, the puncture is configured to form an electrical network from the plurality of liquid metal microdroplets. In some aspects, the electrical network electrically connects between adjacent traces of the plurality of traces. In some aspects, the system may include a pump. In some aspects, the pump is fluidically coupled to the actuation layer by which the one or more bladders are configured to receive a fluid. In some aspects, the system may include a controller. In some aspects, the controller is connected to the plurality of traces. In some aspects, the controller includes one or more processors configured to execute program instructions maintained on a memory. In some aspects, the controller is configured to control actuation of the actuator by selectively causing the pump to pump the fluid. In some aspects, the controller is configured to detect the puncture and the electrical network by monitoring a resistance between the plurality of traces. In some aspects, the controller is configured to cause the electrical network to locally heat the puncture to melt the thermoplastic elastomer layer and seal the puncture. In some aspects, the controller is configured to cause the actuator to form a physical discontinuity along the electrical network.

An actuator is described, in accordance with one or more aspects of the present disclosure. In some aspects, the actuator may include an actuation layer defining one or more bladders. In some aspects, the actuation layer is extensible by inflation of the one or more bladders. In some aspects, the actuator may include a damage detection layer. In some aspects, the damage detection layer is inextensible such that the actuator is configured to actuate with the inflation of the one or more bladders. In some aspects, the damage detection layer is bonded to the actuation layer. In some aspects, the damage detection layer includes a liquid metal-elastomer composite. In some aspects, the liquid metal-elastomer composite includes an elastomer medium, a plurality of liquid metal microdroplets, and a plurality of traces. In some aspects, the plurality of liquid metal microdroplets are dispersed within the elastomer medium. In some aspects, the plurality of traces are embedded within the elastomer medium. In some aspects, the elastomer medium is a dielectric. In some aspects, the plurality of liquid metal microdroplets and the plurality of traces are conductive. In some aspects, the elastomer medium is a thermoplastic elastomer.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1A illustrates a perspective view of an actuator in a bent position, in accordance with one or more embodiments of the present disclosure.

FIG. 1B illustrates an exploded view of the actuator with an actuation layer, a thermoplastic elastomer layer, and a damage detection layer, with the damage detection layer having a liquid metal-elastomer composite with traces running along the length of the actuator, in accordance with one or more embodiments of the present disclosure.

FIG. 1C illustrates a section view through a width of the actuator, the damage detection layer including the liquid metal-elastomer composite, an elastomer substrate, and an elastomer cover, with the liquid metal-elastomer composite having liquid metal microdroplets dispersed in an elastomer medium and having the traces embedded in the elastomer medium, in accordance with one or more embodiments of the present disclosure.

FIG. 1D illustrates a section view through the width of the actuator with a puncture formed through the thermoplastic elastomer layer and the damage detection layer to a bladder of the actuation layer, with the puncture forming an electrical network between the traces around the puncture, in accordance with one or more embodiments of the present disclosure.

FIG. 1E illustrates a section view through the width of the actuator with the puncture being sealed by the thermoplastic elastomer layer after heating the thermoplastic elastomer layer using the traces and the electrical network as a Joule heater, in accordance with one or more embodiments of the present disclosure.

FIG. 1F illustrates a section view through the width of the actuator with a physical discontinuity being formed in the electrical network due to electromigration, in accordance with one or more embodiments of the present disclosure.

FIG. 1G illustrates a bottom view of the actuator with the liquid metal microdroplets having a spherical aspect ratio, in accordance with one or more embodiments of the present disclosure.

FIG. 1H illustrates a bottom view of the actuator with the liquid metal-elastomer composite with the liquid metal microdroplets having an ellipsoidal aspect ratio oriented along the length and along the traces, in accordance with one or more embodiments of the present disclosure.

FIG. 1I illustrates a bottom view of the actuator with the liquid metal-elastomer composite with the traces including interdigitated combs, in accordance with one or more embodiments of the present disclosure.

FIG. 2 illustrates a flow diagram of a method of manufacturing the actuator, in accordance with one or more embodiments of the present disclosure.

FIG. 3 illustrates a section view through the width of the actuator with the damage detection layer having the liquid metal-elastomer composite which is bonded directly to the thermoplastic elastomer layer, in accordance with one or more embodiments of the present disclosure.

FIG. 4 illustrates a section view through the width of the actuator with the damage detection layer having the liquid metal-elastomer composite which is bonded directly to the actuator, where the elastomer medium is a thermoplastic material, in accordance with one or more embodiments of the present disclosure.

FIG. 5 illustrates a simplified block diagram of a system including the actuator, in accordance with one or more embodiments of the present disclosure.

FIG. 6 illustrates a flow diagram of a method of controlling the actuator, in accordance with one or more embodiments of the present disclosure.

FIGS. 7A-7B illustrate plots of failure current of the traces as a function of material thickness and trace width, in accordance with one or more embodiments of the present disclosure.

FIG. 8A-8B illustrate plots of the behavior of electrical networks formed by pressure damage without puncturing, in accordance with one or more embodiments of the present disclosure.

FIG. 9A-9B illustrate plots of the behavior of electrical networks formed by puncturing, in accordance with one or more embodiments of the present disclosure.

FIG. 10A illustrates a top view along the length of the actuator, with the actuator layer being a core layer, in accordance with one or more embodiments of the present disclosure.

FIG. 10B illustrates a section view through the width of the actuator, with the actuation layer being the core layer and with the damage detection layer including the liquid metal-elastomer composite, the elastomer substrate, and the elastomer cover, in accordance with one or more embodiments of the present disclosure.

FIG. 10C illustrates a section view through the width of the actuator, with the actuation layer being the core layer and with the damage detection layer having the liquid metal-elastomer composite which is bonded directly to the thermoplastic elastomer layer, in accordance with one or more embodiments of the present disclosure.

FIG. 10D illustrates a section view through the width of the actuator, with the actuation layer being the core layer and with the damage detection layer having the liquid metal-elastomer composite which is bonded directly to the actuator, where the elastomer medium is a thermoplastic material, in accordance with one or more embodiments of the present disclosure.

### DETAILED DESCRIPTION OF THE INVENTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are generally directed to an intelligent self-healing artificial muscle with mechanisms for damage detection and autonomous repair of puncture damage for self-healing artificial muscles. An actuator may enable detecting the formation of electrical networks in a liquid metal-elastomer layer. Upon detecting the formation of the electrical networks, the actuator may initiate an autonomous repair process through in situ reprocessing, where Joule heating is used to trigger a self-healing material layer. Following the self-healing, the electrical networks may be is reconfigured. Self-healing the punctures and reconfiguring the electrical networks may restore functionality to the actuator without the need for external intervention. The integration of these features enhances the resilience of the actuator and mimics the adaptive capabilities found in biological systems, ultimately leading to more reliable and efficient performance in dynamic environments.

U.S. Pat. No. 11,590,006B2, Titled “systems and Methods of Soft robotic actuation with a liquid metal actuator”; U.S. Pat. No. 11,682,276B2, titled “Multi-site damage sensing and localization soft-matter electronics and related systems and methods”; are incorporated herein by reference in their entirety.

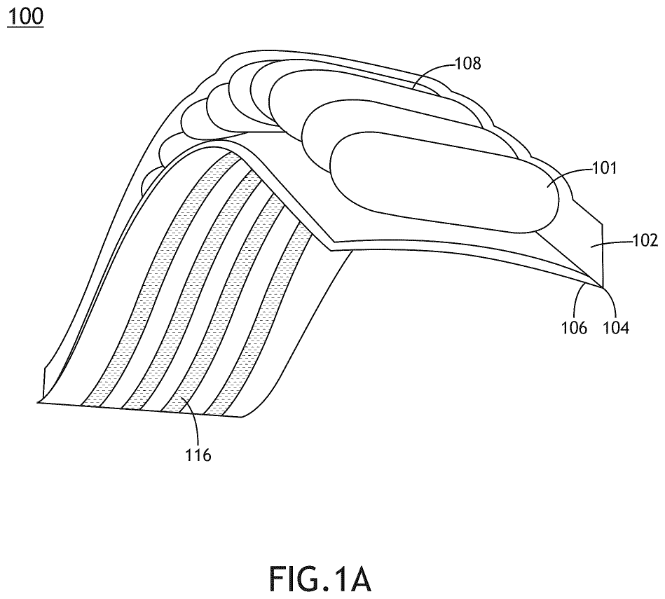

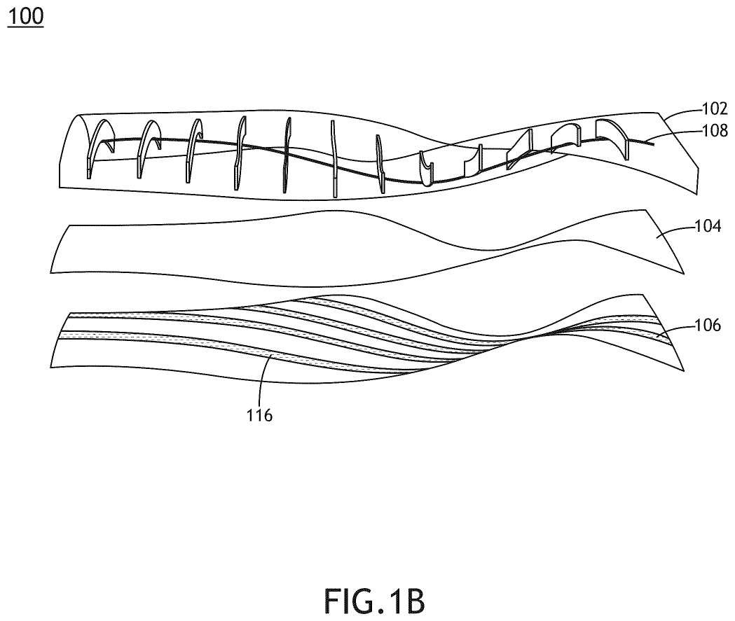

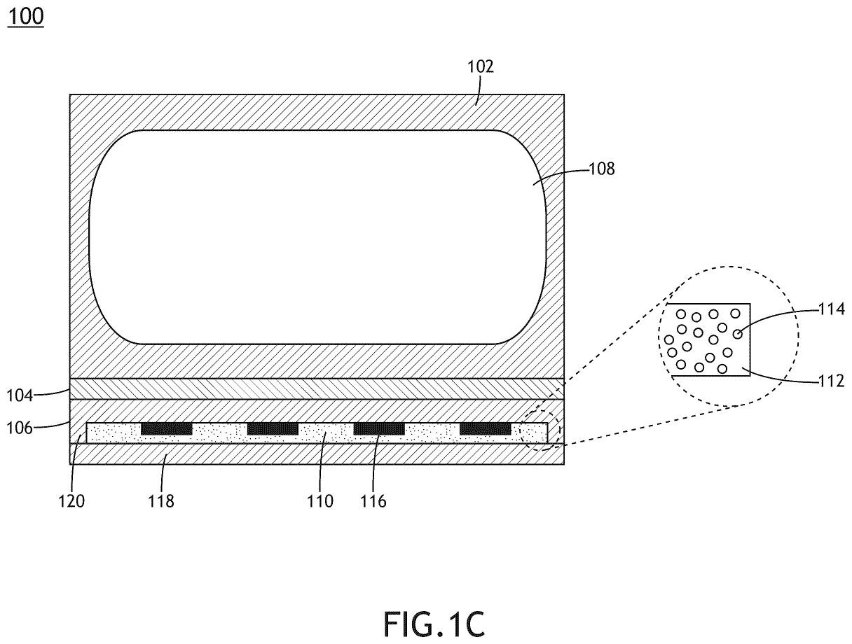

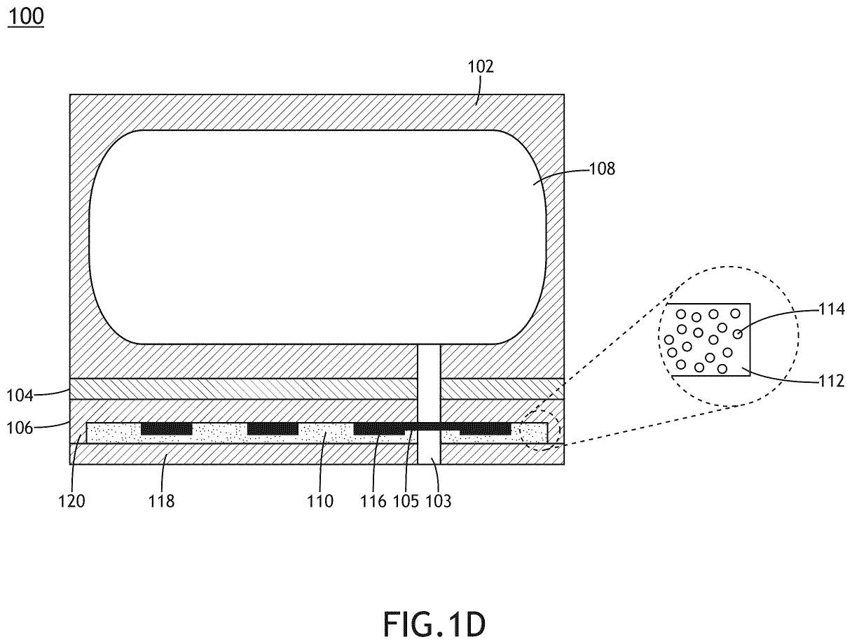

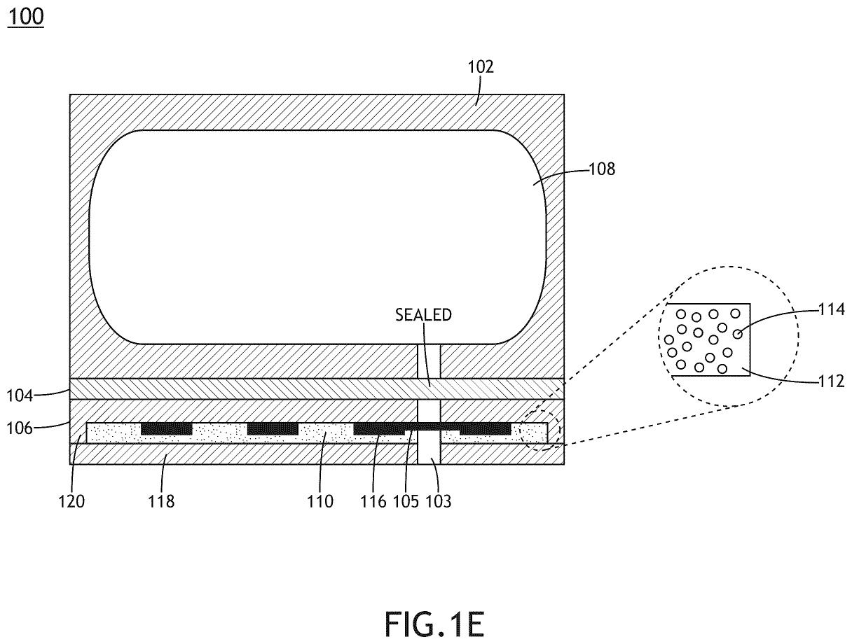

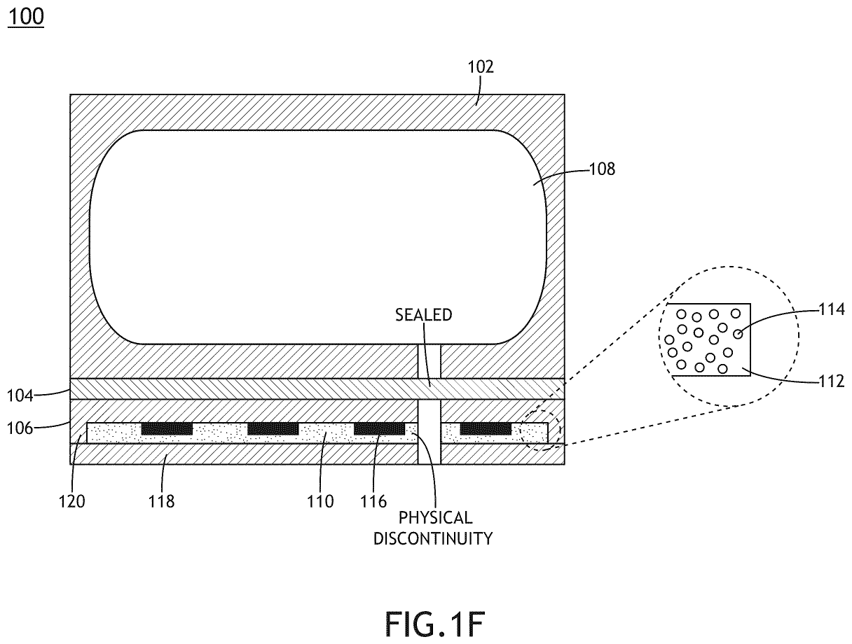

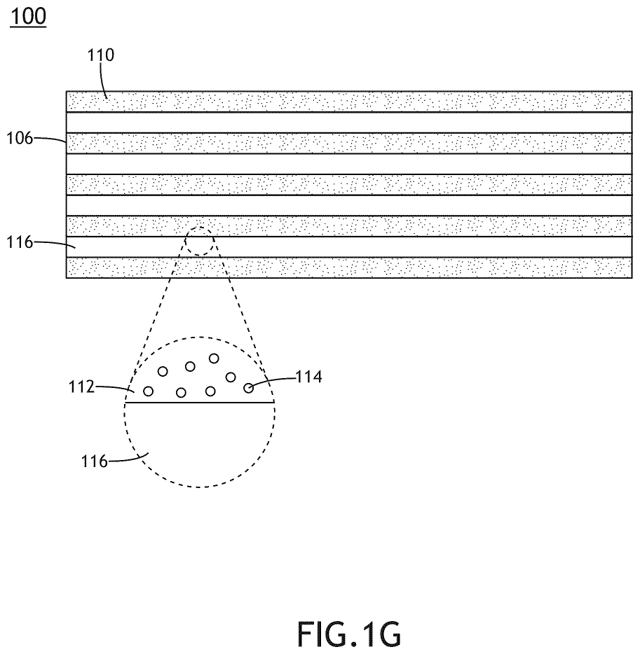

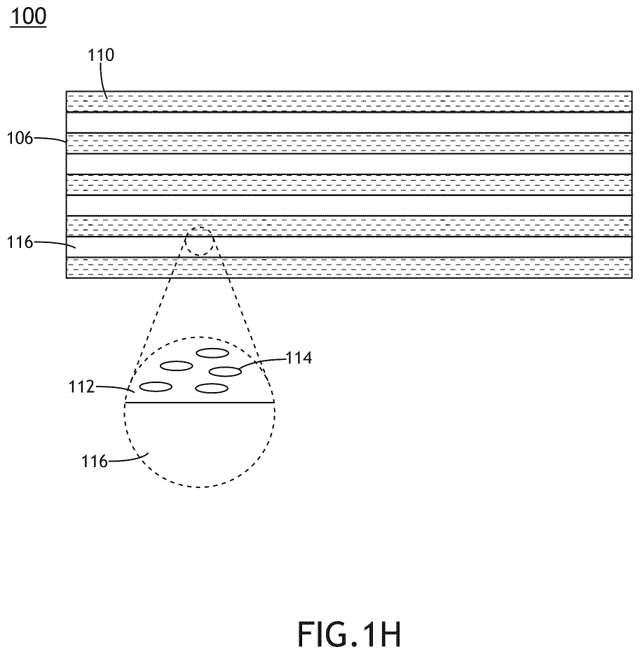

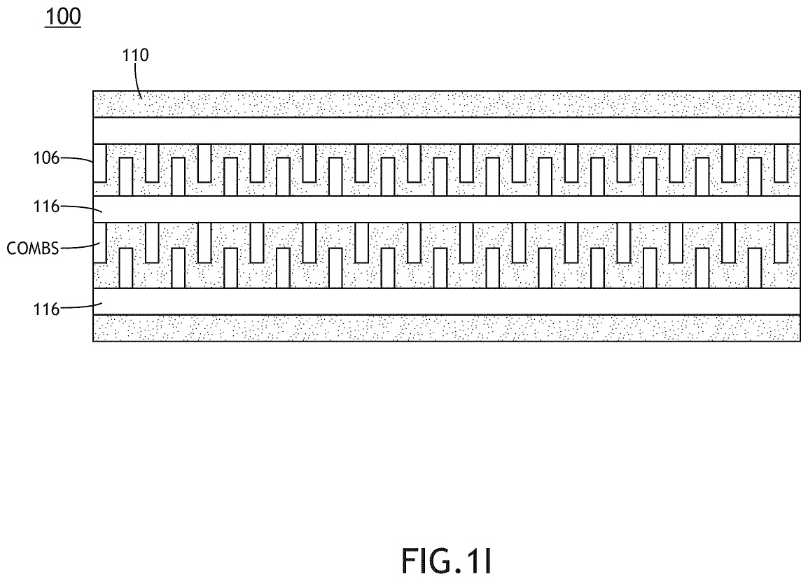

FIGS. 1A-1I illustrates an actuator 100, in accordance with one or more embodiments of the present disclosure. The actuator 100 may be an intelligent self-healing artificial muscle, a fluidic elastomer actuator (FEA), a soft pneumatic actuator, a soft robotic actuator, a self-healing actuator, an artificial finger, or the like. The actuator 100 may include one or more layers or components thereof, such as, but not limited to, an actuation layer 102, a thermoplastic elastomer layer 104, a damage detection layer 106, bladders 108, a liquid metal-elastomer composite 110, an elastomer medium 112, liquid metal microdroplets 114, traces 116, an elastomer substrate 118, an elastomer cover 120, and the like.

The actuation layer 102, the thermoplastic elastomer layer 104, and the damage detection layer 106 may be arranged in any suitable configuration of layers. For example, the thermoplastic elastomer layer 104 may be disposed between the actuation layer 102 and the damage detection layer 106. The thermoplastic elastomer layer 104 may be bonded to the actuation layer 102 and/or the damage detection layer 106. The thermoplastic elastomer layer 104 may be bonded to the actuation layer 102 and/or the damage detection layer 106 by a chemical bond.

The actuation layer 102, the thermoplastic elastomer layer 104, and the damage detection layer 106 may include any suitable shape. For example, the thermoplastic elastomer layer 104 and/or the damage detection layer 106 may be planar layers. The actuation layer 102 may be a top layer of the actuator 100. The thermoplastic elastomer layer 104 and the damage detection layer 106 may be disposed below the actuation layer 102.

The actuator 100 may include the actuation layer 102. The actuation layer 102 may define the bladders 108. The bladders 108 may also be referred to as fluid channels. The bladders 108 may be arranged in series along a length of the actuation layer 102. The actuation layer 102 may define any number of the bladders 108 along the length. The bladders 108 may include any suitable shape. The specific shape of the bladders 108 is not intended to be limiting. It is contemplated that the bladders 108 may include any suitable shape which is configured to receive the fluid 101. The bladders 108 may be inflatable with the fluid 101.

The actuation layer 102 may be extensible. For example, the actuation layer 102 may be extensible along the length of the actuation layer 102. The actuation layer 102 may be extensible by inflation of the bladders 108. Extensible may refer to extending along the length. The actuation layer 102 may be configured to be pressurized with the fluid 101. For example, the bladders 108 of the actuation layer 102 may be inflated with the fluid 101. The fluid 101 may include any suitable fluid, such as a liquid or gas. For example, the actuator 100 may be a hydraulic actuator or a pneumatic actuator where the fluid 101 is respectively the liquid or the gas. The inflation of the bladders 108 may cause the extension of the actuation layer 102. The gas may include any suitable gas such as, but not limited to, an air mixture or the like. The liquid may include any suitable liquid such as, but not limited to, water, a mineral oil, or the like. The material of the fluid 101 may be selected to be compatible with any of the various layers of the actuator 100.

The thermoplastic elastomer layer 104 and/or the damage detection layer 106 may be inextensible and/or strain limiting layers for the actuation layer 102. For example, the thermoplastic elastomer layer 104 and/or the damage detection layer 106 may be inextensible when the actuation layer 102 is pressurized with the fluid 101. The thermoplastic elastomer layer 104 and/or the damage detection layer 106 may strain limiting and/or stiffer than the actuation layer 102. The thermoplastic elastomer layer 104 and/or the damage detection layer 106 may also be compliant to enable bending with the actuation of the actuator 100.

The actuator 100 may be configured to actuate. Any of the various layers of the actuator 100, such as the actuation layer 102, the thermoplastic elastomer layer 104, the damage detection layer 106, the liquid metal-elastomer composite 110, the elastomer substrate 118, the elastomer cover 120, and the like may bend with the actuation of the actuator 100. The extension of the actuation layer 102 together with the in-extension of the thermoplastic elastomer layer 104 and/or the damage detection layer 106 may cause the actuator 100 to actuate. The thermoplastic elastomer layer 104 and/or the damage detection layer 106 may be inextensible such that the actuator 100 is configured to actuate with the inflation of the bladders 108.

The actuator 100 may bend, extend, and/or contract with the actuation. The actuator 100 may bend, extend, and/or contract based on the configuration of the various layers. For example, the actuator 100 may bend with the actuation. The actuator 100 may actuate between a relaxed position and a bent position. The actuator 100 may be planar in the relaxed position. The actuator 100 may bend the actuation layer 102 towards the thermoplastic elastomer layer 104 and/or the damage detection layer 106. The actuator 100 may bend along the length of the actuator 100. The fluid 101 may inflate the actuation layer 102 to inflate the bladders 108 and actuate the actuator 100 to the bent position. For example, when the bladders 108 are inflated with the fluid 101, the difference in strain between the actuation layer 102 and inextensible bottom layers (e.g., the thermoplastic elastomer layer 104 and/or the damage detection layer 106) may cause the actuator 100 to actuate to the bent position. Fluid may be removed from the actuation layer 102 to deflate the bladders 108 and return the actuator 100 to relaxed position. For example, when the bladders 108 are deflated, the match in strain between the actuation layer 102 and inextensible bottom layers may cause the actuator 100 to return to the relaxed position.

The actuator 100 may include the thermoplastic elastomer layer 104. The thermoplastic elastomer layer 104 may be a thermoplastic elastomer (TPE). In this regard, the thermoplastic elastomer layer 104 may be a thermoplastic which may be moldable at a melting temperature and may be an elastomer with viscoelasticity. The TPE may be any suitable class of TPE material according to ISO 18064, such as, but not limited to, a thermoplastic polyamide elastomer (TPA), a thermoplastic copolyester elastomer (TPC), a thermoplastic polyolefin elastomer (TPO), a thermoplastic polystyrene elastomer (TPS), a thermoplastic polyurethane elastomer (TPU), a thermoplastic vulcanizate elastomer (TPV), or an unclassified thermoplastic elastomer (TPZ). For example, the TPE may be the thermoplastic polystyrene elastomer. The thermoplastic polystyrene elastomer may be any suitable styrenic block copolymer, such as, but not limited to, styrene-ethylene-butylene-styrene (SEBS) TPE. For example, the SEBS TPE may be a fully hydrogenated SEBS commercially available at H1521 from Asahi Kasei™, although this is not intended to be limiting. The TPE material may be selected based on the melting temperature, as described further below.

The actuator 100 may include the damage detection layer 106. The damage detection layer 106 may be a soft electronic skin. The damage detection layer 106 may include the liquid metal-elastomer composite 110. The damage detection layer 106 may optionally include the elastomer substrate 118 and/or the elastomer cover 120 in combination with the liquid metal-elastomer composite 110.

The damage detection layer 106 may include the liquid metal-elastomer composite 110. The liquid metal-elastomer composite 110 may exhibit extreme toughening, exceptional electrical and thermal characteristics, and the ability to form electrically conductive pathways.

The liquid metal-elastomer composite 110 may be a colloidal system. For example, the liquid metal-elastomer composite 110 may be a gel. The liquid metal-elastomer composite 110 may be a substantially dilute cross-linked system, which exhibits no flow when in the steady-state. The liquid metal-elastomer composite 110 may include the elastomer medium 112 and the liquid metal microdroplets 114. The elastomer medium 112 and the liquid metal microdroplets 114 may be the continuous phase and the dispersed phase, respectively, of the colloidal system. The elastomer medium 112 and the liquid metal microdroplets 114 may form the gel. The liquid metal microdroplets 114 may be dispersed within the elastomer medium 112. The liquid metal microdroplets 114 may be uniformly or non-uniformly dispersed within the elastomer medium 112. For example, the liquid metal microdroplets 114 may be uniformly dispersed within the elastomer medium 112. The liquid metal-elastomer composite 110 may be stable, such that precipitation of the liquid metal microdroplets 114 within the elastomer medium 112 does not occur under gravity.

The liquid metal microdroplets 114 may be the liquid metal at room temperature (e.g., a liquid at or below 20° C.). The liquid metal microdroplets 114 may be any suitable material which is the liquid metal, such as, but not limited to, a gallium alloy. For example, the liquid metal microdroplets 114 may include the gallium alloy with indium, tin, and the like. For instance, the liquid metal microdroplets 114 may include a gallium and indium alloy, such as eutectic gallium-indium (EGaIn), with a ratio of the gallium and indium may be 3:1 or another suitable ratio. By way of another instance, the liquid metal microdroplets 114 may include a gallium, indium, and tin alloy (e.g., a Galinstan™ alloy).

The liquid metal microdroplets 114 which are the gallium alloy may form a gallium oxide layer around the liquid metal microdroplets 114. The gallium oxide layer may be a passivating oxide skin. The gallium oxide layer may stabilize the liquid metal microdroplets 114 within the elastomer medium 112 as the elastomer medium 112 is formed.

The liquid metal microdroplets 114 may include a median size. The median size of the liquid metal microdroplets 114 may be on the order of single digit of micrometers, tens of micrometers, or hundreds of micrometers. For example, the median size of the liquid metal microdroplets 114 may be between 1 micrometer and 300 micrometers. For instance, the median size of the liquid metal microdroplets 114 may be between 25 micrometer and 100 micrometers, may be between 40 micrometers and 60 micrometers, and the like. In some embodiments, the median size of the liquid metal microdroplets 114 may be about 50 micrometers. The size of the liquid metal microdroplets 114 may be selected based on one or more factors. For example, smaller droplet sizes may be harder to activate within the liquid metal-elastomer composite 110 while larger droplets sizes may cause more leaking of the liquid metal microdroplets 114 from the liquid metal-elastomer composite 110 during a puncture.

The liquid metal-elastomer composite 110 may include a select volume loading percentage of the liquid metal microdroplets 114 in the liquid metal-elastomer composite 110. The volume loading percentage may also be referred to as a volume fraction. The volume loading percentage may be a volume of the liquid metal microdroplets 114 divided by the sum of the volume of the elastomer medium 112 and the liquid metal microdroplets 114. For example, the volume loading percentage of the liquid metal microdroplets 114 in the liquid metal-elastomer composite 110 may be between 1% and 80% by volume, may be between 10% and 80% by volume, may be between 20% and 70% by volume, may be between 30% and 60% by volume, may be between 45% and 55% by volume, or the like. For example, the volume loading percentage of the liquid metal microdroplets 114 may be 50% by volume (e.g., a 1:1 ratio of the liquid metal microdroplets 114 to the elastomer medium 112 by volume), although this is not intended to be limiting. The volume loading percentage may be selected to enable forming the traces 116 by mechanically sintering the liquid metal microdroplets 114 together.

The liquid metal microdroplets 114 may be a liquid phase or may be a multi-phase inclusion. Much of the present disclosure is directed to the liquid metal microdroplets 114 being the liquid phase with the gallium alloy. It is further contemplated that the liquid metal microdroplets 114 may be the colloidal system. The liquid metal microdroplets 114 being the multi-phase inclusion may be a colloidal system (e.g., a sol) and/or a microcapsule. For example, the multi-phase inclusion may be the colloidal system. The colloidal system may include the gallium alloy thereof which is the liquid metal and the continuous phase and may also include a solid particle filler which is the dispersed phase within the continuous phase. The solid particle filler may include a select loading. For example, the solid particle fillers may be below 30% by weight of the liquid metal microdroplets 114. The loading of the solid particle filler may be selected to provide a negligible influence of the mechanical properties of the liquid metal microdroplets 114.

The liquid metal microdroplets 114 may be spherical or ellipsoidal. The liquid metal microdroplets 114 may have an aspect ratio. The aspect ratio may define whether the liquid metal microdroplets 114 are spherical or ellipsoidal (e.g., an aspect ratio of 1 is spherical while an aspect ratio of greater than 1 is ellipsoidal). The aspect ratio may be defined relative to the median diameter of the liquid metal microdroplets 114. In this regard, the median diameter of the liquid metal microdroplets 114 may be the smallest principal diameter of the liquid metal microdroplets 114. The aspect ratio may be any suitable aspect ratio, such as, but not limited to, between 1 and 30, between 1 and 10, between 1 and 2, or the like. In embodiments, the liquid metal microdroplets 114 are spherical, although this is not intended to be limiting. In embodiments, the liquid metal microdroplets 114 may be ellipsoidal. The largest principal diameter of the liquid metal microdroplets 114 may include a select orientation. The orientation of the largest principal diameter may change the electromigration and/or detection provided by the liquid metal-elastomer composite 110. For example, the largest principal diameter of the liquid metal microdroplets 114 may be oriented along the length of the actuator 100 and/or along the orientation of the traces 116. It is contemplated that the orienting the largest principal diameter of the liquid metal microdroplets 114 along the traces 116 may be beneficial to enable reducing the width between the traces 116. For example, the orientation may enable the traces 116 to be smaller and closer together because the traces 116 may handle a larger current before electromigration.

The liquid metal microdroplets 114 and/or the traces 116 may be electrically conductive. The elastomer medium 112 may be dielectric. The elastomer medium 112 may insulate electric current, thereby preventing electric current flow between the liquid metal microdroplets 114 and/or the traces 116.

The damage detection layer 106 may be a three-layer composite of the elastomer substrate 118, the liquid metal-elastomer composite 110, and the elastomer cover 120. The liquid metal-elastomer composite 110 may be disposed between and bonded to the elastomer cover 120 and the elastomer substrate 118. The elastomer substrate 118 and the elastomer cover 120 may not include the liquid metal microdroplets 114 and/or may be unfilled elastomers. The elastomer substrate 118 may be a substrate on which the liquid metal-elastomer composite 110 is supported. The elastomer cover 120 may be disposed between and bonded to the thermoplastic elastomer layer 104 and the liquid metal-elastomer composite 110. The elastomer cover 120 may cover the liquid metal-elastomer composite 110. The elastomer cover 120 may also surround the liquid metal-elastomer composite 110 around the edge of the liquid metal-elastomer composite 110, with the portion of the elastomer cover 120 which surrounds the edge of the liquid metal-elastomer composite 110 being bonded to the elastomer substrate 118. Providing the damage detection layer 106 with the elastomer cover 120 and the elastomer substrate 118 may be beneficial for ease-of-manufacture of the damage detection layer 106. Although the damage detection layer 106 is described as including the elastomer substrate 118 and the elastomer cover 120, this is not intended to be limiting as described further herein.

The elastomer cover 120 may be disposed between the thermoplastic elastomer layer 104 and the liquid metal-elastomer composite 110. For example, the thermoplastic elastomer layer 104 may be bonded to the elastomer cover 120 of the damage detection layer 106.

Any of the thermoplastic elastomer layer 104, the liquid metal-elastomer composite 110, the elastomer substrate 118, and/or the elastomer cover 120 may include a layer thickness of between 0.05 millimeters and 2 millimeters. For example, the layer thickness may be between 0.25 millimeters and 0.75millimeters. For instance, the layer thickness may be about 0.5 millimeters. A layer thickness of the damage detection layer 106 may be the sum of the layer thicknesses of the liquid metal-elastomer composite 110, the elastomer substrate 118, and/or the elastomer cover 120.

The actuation layer 102, the elastomer medium 112, the elastomer substrate 118, and/or the elastomer cover 120 may include any suitable elastomer material. For example, the actuation layer 102, the elastomer medium 112, the elastomer substrate 118, and/or the elastomer cover 120 may be thermoset elastomers. The thermoset elastomers may include covalent bonds which crosslink polymer chains, providing thermal stability. The thermoset elastomers may be any suitable thermoset elastomers such as, but not limited to, silicone elastomers, polyurethanes, polyvinyl siloxane, butyl rubber, fluorosilicate, styrene butadiene rubber, acrylonitriles, fluoropolymers, copolymers thereof, blends thereof, or the like. For example, the silicone elastomer may include polydimethylsiloxane (PDMS), commercially available as Sylgard™ 184 silicon elastomer.

Although the actuation layer 102, the elastomer medium 112, the elastomer substrate 118, and/or the elastomer cover 120 are described as being thermoset elastomers, this is not intended as a limitation of the present disclosure. For example, the elastomer material of the actuation layer 102, the elastomer medium 112, the elastomer substrate 118, and/or the elastomer cover 120 may be thermoplastic elastomers. However, the elastomer material being the thermoset elastomers may be advantageous for preventing melting of the actuation layer 102, the elastomer medium 112, the elastomer substrate 118, and/or the elastomer cover 120 during Joule heating, as will be described further below. Preventing the melting of the actuation layer 102 may be beneficial to maintain the structure of the bladders 108. Preventing the melting of the elastomer medium 112, the elastomer substrate 118, and/or the elastomer cover 120 may be beneficial to maintain the dispersion of the liquid metal microdroplets 114 within the elastomer medium 112.

The liquid metal-elastomer composite 110 may include the traces 116. The liquid metal-elastomer composite 110 may include any number of the traces 116. The traces 116 may also be referred to as conductive traces, monitoring traces, or the like. The traces 116 may be embedded within the elastomer medium 112. The liquid metal microdroplets 114 may be dispersed within the elastomer medium 112 around the traces 116. The traces 116 may be conductive for power and signal transmission. The traces 116 may be electrically insulated within the liquid metal-elastomer composite 110. For example, the traces 116 may be electrically insulated from adjacent of the traces 116 and/or the liquid metal microdroplets 114 via the elastomer medium 112.

The traces 116 may be formed of any conductive material. For example, the traces 116 may be formed of a portion of the liquid metal microdroplets 114. For example, the traces 116 may be formed of the portion of the liquid metal microdroplets 114 by mechanically sintering the liquid metal microdroplets 114 together. The remainder of the liquid metal microdroplets 114 may be disposed around the traces 116. Although the traces 116 are described as being formed of the liquid metal microdroplets 114, this is not intended as a limitation of the present disclosure. It is contemplated that the traces 116 may be any suitable form of a conductive and flexible trace. However, the forming the traces 116 of the liquid metal microdroplets 114 may be beneficial for ease-of-manufacturing and/or to ensure flexure with the actuation of the actuator 100.

The traces 116 may include a select cross-sectional area. The cross-sectional area of the traces 116 may refer to the width and depth of the traces 116. The cross-sectional area of the traces 116 may control the resistance of the traces 116. For example, the resistance may be proportional to the cross-sectional area.

The traces 116 may or may not be fully through the thickness of the liquid metal-elastomer composite 110. For example, the depth of the traces 116 may be partially through the depth of the liquid metal-elastomer composite 110. The depth of the traces 116 may be controlled by controlling the thickness of the liquid metal-elastomer composite 110.

The traces 116 may include a select width. For example, the width of the traces 116 may be between 0.25 millimeters and 5 millimeters. For instance, the width of the traces 116 may be between 0.5 millimeter and 2 millimeters. For instance, the width of the traces 116 may be about 2 millimeters. The width of the traces 116 may be selected to be sufficiently large to prevent electromigration of the traces 116 when electro-migrating the electrical networks 105, as described further herein.

The traces 116 may be arranged with a trace-to-trace spacing between adjacent of the traces 116. The trace-to-trace spacing may separate the traces 116 from each other, thereby forming an open circuit between each of the traces 116. The trace-to-trace spacing may refer to the closest width between the traces 116. The trace-to-trace spacing may be any suitable value. For example, the trace-to-trace spacing may be at least 20 millimeters, at least 15 millimeters, at least 10 millimeters, at least 5 milliners, at least 2 millimeters, at least 1 millimeter, at least at least 0.5 millimeters, at least 0.25 millimeters, or the like. Reducing the trace-to-trace spacing may be beneficial to increase the ability to form the electrical networks 105 between adjacent of the traces 116, thereby enabling the detection of the punctures 103. However, a lower bound for the trace-to-trace spacing may be based on the ability to mechanically sinter the traces 116 without shorting between the traces 116 and/or maintaining a sufficient width for each of the traces 116.

The traces 116 may include any suitable arrangement. For example, the traces 116 may be linear and may be arranged in parallel. The traces 116 which are linear may be oriented in any suitable orientation such as, but not limited along the length of the actuator 100, along the width of the actuator 100 (e.g., perpendicular to the length), or another orientation between the length and the width. Furthermore, although the traces 116 are described as being linear, this is not intended as a limitation of the present disclosure. It is contemplated that the traces 116 may be non-linear such as, but not limited to, interdigitated combs, or the like. However, the traces 116 being linear may be beneficial for ease-of-manufacture.

The actuator 100 may be configured to be form the punctures 103. The punctures 103 may be through the damage detection layer 106 and/or the thermoplastic elastomer layer 104 into the bladders 108. The punctures 103 may enable the fluid 101 to leak from the bladders 108. The leak of the fluid 101 from the bladders 108 may prevent the actuation of the actuator 100. The punctures 103 may include any form of a puncture, such as, but not limited to, a cut, a tear, a hole punch, or the like.

The punctures 103 may form the electrical networks 105. The electrical networks 105 may be within the liquid metal-elastomer composite 110. For example, the electrical networks 105 may be formed by the punctures 103 creating internal tensile stress concentrations around the liquid metal microdroplets 114, causing the elastomer medium 112 between the liquid metal microdroplets 114 to rupture. The rupture of the elastomer medium 112 may leads to the in-situ flow of the liquid metal microdroplets 114 and formation of the electrical networks 105 by percolation. The electrical networks 105 may thus be the same gallium alloy as the liquid metal microdroplets 114 and/or the traces 116. The electrical networks 105 may also be conductive pathways. The electrical networks 105 may be formed around the punctures 103.

The electrical networks 105 may electrically connect between the traces 116. For example, when the punctures 103 occurs in an area that overlaps between adjacent of the traces 116, the electrical networks 105 are formed between the traces 116. The electrical networks 105 electrically connecting between the traces 116 may lowering the resistance between the traces 116. The damage detection layer 106 may enable the detection and localization of the punctures 103 by detecting the change in resistance between the traces 116 due to the formation of the electrical networks 105. For example, the punctures 103 between two adjacent of the traces 116 can be detected based on the change in resistance between the traces 116. By integrating the liquid metal microdroplets 114 within the elastomer medium 112, the system can detect and localize the punctures 103 through the formation of the electrical networks 105.

The electrical networks 105 may have a higher resistance than the traces 116. For example, the width of the electrical networks 105 may be less than the width of the traces 116. In this regard, a highest point of resistance may be along the electrical networks 105 and not along the traces 116. The resistance of the electrical networks 105 being higher than the traces 116 may enable the electrical networks 105 to function as a local Joule heater around the punctures 103.

The electrical networks 105 may be configured to locally heat the punctures 103 to melt the thermoplastic elastomer layer 104. The actuator 100 may heat the thermoplastic elastomer layer 104 up to a melting temperature, thereby melting the thermoplastic elastomer layer 104. The actuator 100 may be configured to melt the thermoplastic elastomer layer 104 around the punctures 103 using the traces 116 and/or the electrical networks 105. The interaction between the traces 116 and the electrical networks 105 created by the punctures 103 enables the facilitation of localized Joule heating elements. The traces 116 may be configured to receive a current, the current flowing from the traces 116 through the electrical networks 105, thereby heating the electrical networks 105 the thermoplastic elastomer layer 104 around the punctures 103. For example, the thermoplastic elastomer layer 104 may be locally heated by the electrical networks 105 for several minutes to melt the thermoplastic elastomer layer 104.

The thermoplastic elastomer layer 104 may be self-healing. The thermoplastic elastomer layer 104 may be self-healing by melting and filling the punctures 103. The melting of the thermoplastic elastomer layer 104 may cause the thermoplastic to flow into the punctures 103 thereby sealing the punctures 103 and/or the bottom of the actuation layer 102. Self-healing the punctures 103 may be beneficial to allow the actuator 100 to continue to actuate without leaking the fluid 101 from the bladders 108 through the punctures 103. Thus, the punctures 103 through the bottom of the actuation layer 102 may be repaired by the self-healing.

The actuator 100 may be configured to form a physical discontinuity along the electrical networks 105. The actuator 100 may form the physical discontinuity along the electrical networks 105 by receiving a current along the traces 116. The current may be sufficiently high to induce the physical discontinuity by electromigration and/or thermal failure mechanisms of the electrical networks 105. The electromigration and/or thermal failure may occur in the area of highest resistance (e.g., the electrical networks 105). The traces 116 may be designed with a sufficiently large cross-section so that the highest resistance and the circuit reconfiguration coincides with the electrical networks 105 and not the traces 116. The electrical networks 105 may be reconfigured back into the liquid metal microdroplets 114 within the elastomer medium 112.

The actuator 100 may form the physical discontinuity along the electrical networks 105 after self-healing the thermoplastic elastomer layer 104. The current causing the melting of the thermoplastic elastomer layer 104 may be lower than the current at which electromigration and/or thermal failure of the electrical networks 105 occurs. For example, the material of the thermoplastic elastomer layer 104 may be selected with a sufficiently low melt temperature to ensure the melting occurs before the physical discontinuity. After self-healing using the current, the electrical networks 105 may be reconfigured by increasing the current until electromigration and/or thermal failure occurs within the electrical networks 105, resulting in the physical discontinuity between the traces 116. By continuing to increase the applied current, the electrical networks 105 may be reconfigured using electromigration and thermal mechanisms to create physical discontinuities, ultimately restoring the functionality of the actuator 100. The self-healing followed by the forming the physical discontinuity may reset the actuator 100, allowing additional of the punctures 103 and electrical networks 105 to be detected, self-healed, and reconfigured.

The actuator 100 may enable detection of the punctures 103 via the electrical networks 105, self-healing for the punctures 103, and reconfiguration of the electrical networks 105, all without the need for manual intervention or external healing mechanisms. For example, the damage detection layer 106 may enable detecting the punctures 103 by the change in resistance between the traces 116 caused by the electrical networks 105. By way of another example, the self-healing may repair the punctures 103 automatically without requiring a manual reprocessing using a solvent. By way of another example, the actuator 100 may enable the reconfiguration of the electrical networks 105 using high current densities, employing electromigration and thermal mechanisms to restore functionality without manual intervention.

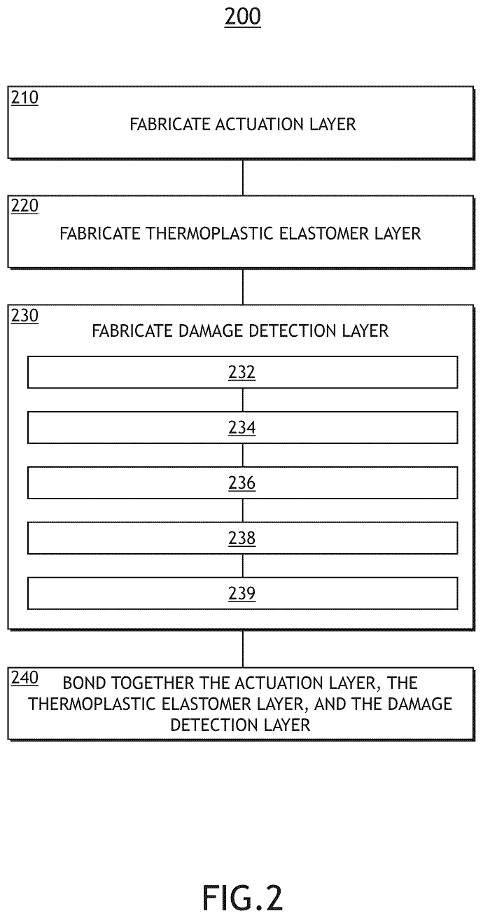

FIG. 2 illustrates a flow diagram of a method 200, in accordance with one or more embodiments of the present disclosure. The method 200 may be a method of manufacturing the actuator 100. The embodiments and the enabling technologies described previously herein in the context of the actuator 100 should be interpreted to extend to the method 200. It is further noted, however, that the method 200 is not limited to the architecture of the actuator 100.

In a step 210, the actuation layer 102 with the bladders 108 may be fabricated. For example, the actuation layer 102 with the bladders 108 may be fabricated by mixing and degassing an uncured silicone elastomer (ExSil100, Gelest™) at a ratio of 100:1 prepolymer to crosslinker. The uncured elastomer may be cast into a PTFE mold and cured at 100° C. for 8 hours, thereby forming the actuation layer 102.

In a step 220, the thermoplastic elastomer layer 104 may be fabricated. For example, the thermoplastic elastomer layer 104 may be fabricated by dissolving styrene-ethylene-butylene-styrene (SEBS) TPE (H1521, Asahi Kasei) in toluene at a ratio of 25 g SEBS to 70 ml solvent. The dissolved SEBS may be degassed for 10 minutes before being cast onto a glass sheet and left under a fume hood overnight to allow the toluene to evaporate, thereby forming the thermoplastic elastomer layer 104.

In a step 230, the damage detection layer 106 may be fabricated. The damage detection layer 106 may be fabricated with the liquid metal-elastomer composite 110, the elastomer substrate 118, and/or the elastomer cover 120. The damage detection layer 106 may be fabricated may be fabricated by one or more sub-steps. In a sub-step 232, an uncured mixture of the liquid metal-elastomer composite 110 may be created. For example, uncured mixture of the liquid metal-elastomer composite 110 may be created by shear mixing gallium-based liquid metal with uncured silicone elastomer (Sylgard 184™, Dow™) at a 1:1 volume ratio, forming a suspension of the liquid metal microdroplets 114 (about 50 μm particles) in the elastomer medium 112. In a sub-step 234, the elastomer substrate 118 may be applied to a glass substrate and cured. In a sub-step 236, a mask may be applied to the elastomer substrate 118 and a layer of the liquid metal-elastomer composite 110 may be cast and cured onto the elastomer substrate 118. The mask may be removed after curing the liquid metal-elastomer composite 110. In a sub-step 238, the elastomer cover 120 may be cast on top of the liquid metal-elastomer composite 110 and subsequently cured. Each of the elastomer substrate 118, the liquid metal-elastomer composite 110, and the elastomer cover 120 may be 0.5 millimeters thick, for example, and may be applied using a thin film applicator, and cured at 100° C. for 1 hour. In a sub-step 239, the traces 116 may be formed from the liquid metal microdroplets 114 within the elastomer medium 112 after curing the elastomer medium 112 (e.g., after the sub-step 236 and/or the sub-step 238) by mechanically sintering using a scoring wheel or another form of mechanical pressure. The application of mechanical pressure may induce the formation of the traces 116 within the liquid metal-elastomer composite 110. To ensure consistent results, the traces 116 may be created using an X-Y pen plotter (Maker 3™, Cricut™) equipped with the scoring wheel to selectively apply pressure to predefined regions of the liquid metal-elastomer composite 110, causing the rupture of the liquid metal microdroplets 114 and the in-situ formation of the traces 116 in the desired pattern. The width of the traces 116 may controlled by adjusting the number of adjacent line paths drawn by the pen plotter, while the depth of the traces 116 was controlled by adjusting the thickness of the liquid metal-elastomer composite 110.

In a step 240, the actuation layer 102, the thermoplastic elastomer layer 104, and the damage detection layer 106 may be bonded together. For example, the actuation layer 102, the thermoplastic elastomer layer 104, and the damage detection layer 106 may be bonded together by treating the layers treated with oxygen plasma and submerging the thermoplastic elastomer layer 104 in an aqueous solution of 4% v/v APTES (440140, Sigma Aldrich) for 15 minutes and then dried with compressed air. The actuation layer 102, the thermoplastic elastomer layer 104, and the damage detection layer 106 may then be assembled and placed in an oven at 80° C. for 15 minutes, to form the actuator 100. It is contemplated that the step 210, the step 220, and the step 230 may be performed in any order before the step 240.

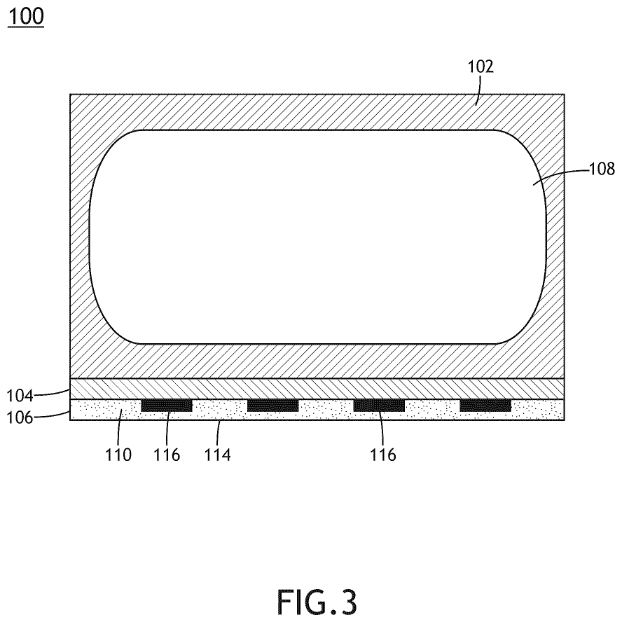

FIG. 3 illustrates the actuator 100, in accordance with one or more embodiments of the present disclosure. The actuator 100 may include one or more layers or components thereof, such as, but not limited to, the actuation layer 102, the thermoplastic elastomer layer 104, the damage detection layer 106, the bladders 108, the liquid metal-elastomer composite 110, the elastomer medium 112, the liquid metal microdroplets 114, and/or the traces 116. The discussion of the actuation layer 102, the thermoplastic elastomer layer 104, the damage detection layer 106, the bladders 108, the liquid metal-elastomer composite 110, the elastomer medium 112, the liquid metal microdroplets 114, and/or the traces 116 is incorporated herein by reference in the entirety.

Although the damage detection layer 106 is described as including the elastomer substrate 118 and the elastomer cover 120, this is not intended to be limiting. The damage detection layer 106 may include the liquid metal-elastomer composite 110 without including the elastomer substrate 118 and/or the elastomer cover 120. For example, the thermoplastic elastomer layer 104 may be bonded to the liquid metal-elastomer composite 110.

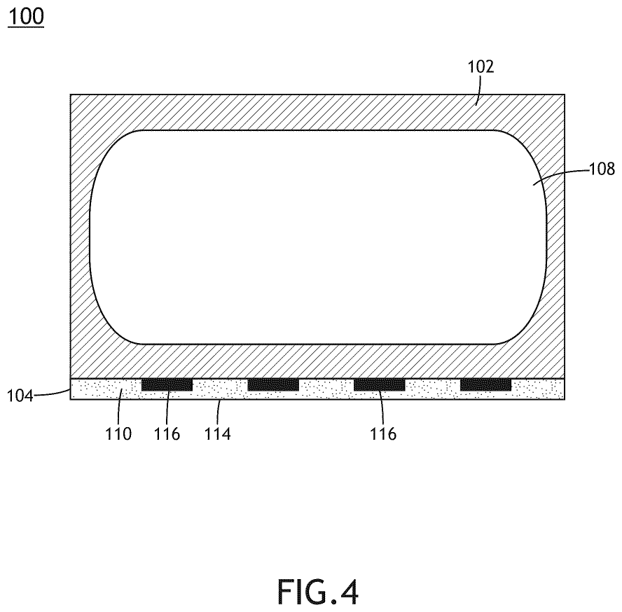

FIG. 4 illustrates the actuator 100, in accordance with one or more embodiments of the present disclosure. The actuator 100 may include one or more layers or components thereof, such as, but not limited to, the actuation layer 102, the damage detection layer 106, the bladders 108, the liquid metal-elastomer composite 110, the elastomer medium 112, the liquid metal microdroplets 114, and/or the traces 116. The discussion of the actuation layer 102, the damage detection layer 106, the bladders 108, the liquid metal-elastomer composite 110, the elastomer medium 112, the liquid metal microdroplets 114, and/or the traces 116 is incorporated herein by reference in the entirety.

Although the actuator 100 is described as including the thermoplastic elastomer layer 104 and the elastomer medium 112 is described as the thermoset elastomer, this is not intended as a limitation of the present disclosure. The actuator 100 may include the actuation layer 102 and the damage detection layer 106 without the thermoplastic elastomer layer 104. In this example, the damage detection layer 106 may be a damage detection and thermoplastic elastomer layer. The damage detection layer 106 may be bonded to the actuation layer 102. For example, the liquid metal-elastomer composite 110 may be bonded to the actuation layer 102. The elastomer medium 112 may be the thermoplastic elastomer. The thermoplastic elastomer may be any suitable thermoplastic elastomer material. The discussion of the various thermoplastic elastomer materials of the thermoplastic elastomer layer 104 is incorporated herein by reference as to the thermoplastic elastomer of the elastomer medium 112. The thermoplastic elastomer of the damage detection layer 106 may self-heal with the Joule heating by the electrical networks 105.

It is contemplated that one advantage of the actuator 100 which includes the thermoplastic elastomer layer 104 disposed between the actuation layer 102 and the damage detection layer 106 may be that the thermoplastic elastomer layer 104 may prevent the current from shorting from the traces 116 into the fluid 101 within the bladders 108.

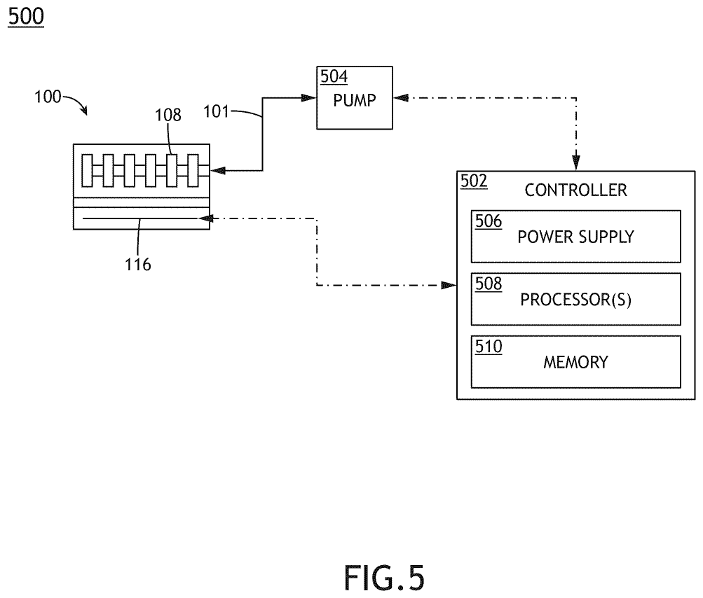

FIG. 5 illustrates a system 500, in accordance with one or more embodiments of the present disclosure. The system 500 may include one or more components such as, but not limited to, the actuator 100, a controller 502, a pump 504, a power supply 506, processors 508, memory 510, and the like.

The system 500 may include any of the various permutations of the actuator 100.

The system 500 may include the controller 502. The controller 502 may include one or more of the processors 508 configured to execute program instructions maintained on the memory 510. In this regard, the processors 508 of the controller 502 may execute any of the various process steps described throughout the present disclosure.

The system 500 may include the pump 504. The pump 504 may be fluidically coupled to the actuation layer 102 (e.g., the bladders 108). The actuation layer 102 may be configured to receive the fluid 101 from the pump 504. The pump 504 may inflate the bladders 108 with the fluid 101 by pumping the fluid 101 into the bladders 108 and may deflate the bladders 108 by pumping the fluid 101 from the bladders 108 thereby actuating the actuator 100. The controller 502 may control the pump 504. For example, the controller 502 may selectively cause the pump 504 to pump the fluid 101, thereby controlling the actuation of the actuator 100.

The controller 502 may be connected to the traces 116 of the liquid metal-elastomer composite 110. The controller 502 may be connected to the traces 116 of the liquid metal-elastomer composite 110 using any suitable electrical connection such as, but not limited to, temporary connections, soldered connections, or the like. The controller 502 may monitor the resistance between the traces 116. The controller 502 may detect the formation of the punctures 103 and/or the electrical networks 105 by monitoring the resistance between the traces 116. For example, the controller 502 detect the change in the resistance between the traces 116 due to the electrical networks 105, thereby detecting the punctures 103.

The controller 502 may supply the current to the traces 116. The controller 502 may include the power supply 506 for supplying the current to the traces 116. The controller 502 may supply the current to the traces 116 causing the self-healing of the punctures 103 and/or the physical discontinuity in the electrical networks 105.

The controller 502 may control the current to the traces 116 causing the melting of the thermoplastic elastomer layer 104 using an open-loop control. For example, the controller 502 may apply a ramping current and/or a step increasing current to perform the Joule heating. The ramping current may refer to a current which is continually increasing. The step increasing current may refer to a current which increases in discrete steps. The controller 502 may ramp and/or step increase the current to a level which is below the electromigration threshold. The controller 502 may then maintain the current at the level for a preset time to ensure the melting.

Although the controller 502 is described as controlling the heating of the thermoplastic elastomer layer 104 using an open-loop control, this is not intended as a limitation of the present disclosure. It is contemplated that the controller 502 may control the heating of the thermoplastic elastomer layer 104 using a closed-loop control by measuring the resistance of between the traces 116 as a means for detecting the temperature of the thermoplastic elastomer layer 104. The controller 502 may cycle between applying the current to the traces 116 and measuring the resistance between the traces 116. The resistance may correlate to the temperature of the material at the location of the traces 116. The controller 502 may use the resistance as a closed-loop feedback control to detect the temperature of the thermoplastic elastomer layer 104. For example, the controller 502 may sense the thermoplastic elastomer layer 104 is heated at or above the melting temperature and may maintain the heat for a select period to confirm sealing the punctures 103.

The controller 502 may also cause the actuator 100 to form the physical discontinuity along the electrical networks 105. The controller 502 may control the current to the traces 116 causing the physical discontinuity in the electrical networks 105. The controller 502 may supply the current at or above the electromigration threshold causing the physical discontinuity in the electrical networks 105 after causing the melting of the thermoplastic elastomer layer 104. For example, the controller 502 may supply the current at or above the electromigration threshold after the open-loop and/or closed-loop control. The electromigration threshold may include any suitable current. For example, the current causing the physical discontinuity may be between about 0.1 amps and 2 amps. For instance, the current causing the physical discontinuity may be between about 0.2 amps and 0.3 amps as was experimentally determined, as described further herein.

The power supply 506 may be a direct current supply and/or an alternating current supply. It is contemplated that the alternating current supply may cause the electromigration and/or thermal failure of the electrical networks 105 at a higher current than the direct current supply. For example, the alternating current supply may cause the liquid metal microdroplets 114 to flow back and forth with the alternating current while the direct current supply may electro-migrate the liquid metal microdroplets 114 in one direction in one direction causing the electromigration at a lower current.

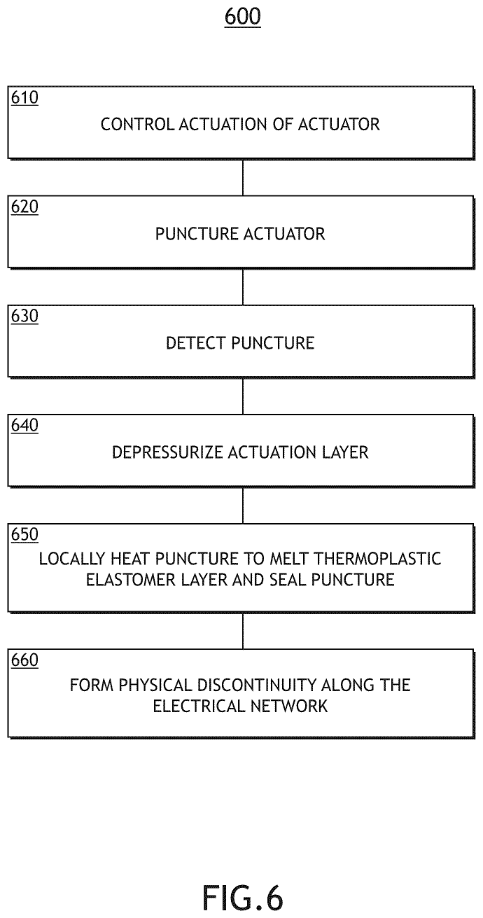

FIG. 6 illustrates a flow diagram of a method 600, in accordance with one or more embodiments of the present disclosure. The method 600 may be a method of controlling the actuator 100 by the controller 502. The embodiments and the enabling technologies described previously herein in the context of the actuator 100 and the system 500 should be interpreted to extend to the method 600. For example, one or more steps of the method 600 may be executed by the controller 502. It is further noted, however, that the method 600 is not limited to the architecture of the actuator 100 and/or the system 500.

In a step 610, the controller 502 may selectively cause the pump 504 to pump the fluid 101, thereby controlling the actuation of the actuator 100.

In a step 620, the actuator 100 may be punctured, forming the electrical networks 105 between the traces 116. For example, the actuator 100 may be punctured by an external component such as a knife or an object to be gripped. The punctures 103 may damage the damage detection layer 106 and the thermoplastic elastomer layer 104.

In a step 630, the controller 502 may detect the punctures 103 by detecting a change in resistance between the traces 116. For example, the controller 502 may detect a decrease in the resistance due to the formation of the electrical networks 105.

In a step 640, the controller 502 may cause the pump 504 to depressurize the actuation layer 102. Depressurizing the actuation layer 102 may remove the fluid 101 from the bladders 108.

In a step 650, the controller 502 may cause the electrical networks 105 to locally heat the punctures 103 to melt the thermoplastic elastomer layer 104 and seal the punctures 103. The controller 502 may apply current to the traces 116 causing the thermoplastic elastomer layer 104 to melt and self-heal the punctures 103. The controller 502 may apply the current at or below the electromigration threshold. The controller 502 may apply the current using the open-loop and/or the closed-loop control.

In a step 660, the controller 502 may cause the actuator 100 to form the physical discontinuity along the electrical networks 105. The controller 502 may increase the current above the electromigration threshold causing the physical discontinuity via the electromigration and thermal failure, thereby reconfiguring the electrical networks 105. The actuator 100 may now be repaired and ready for actuation.

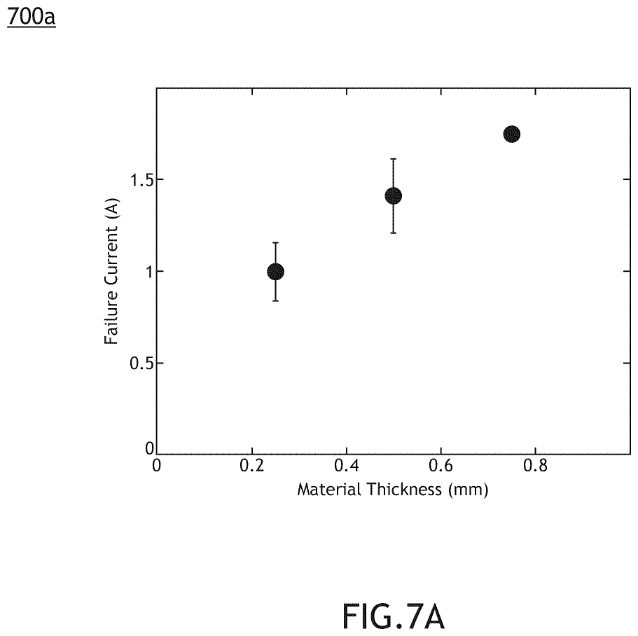

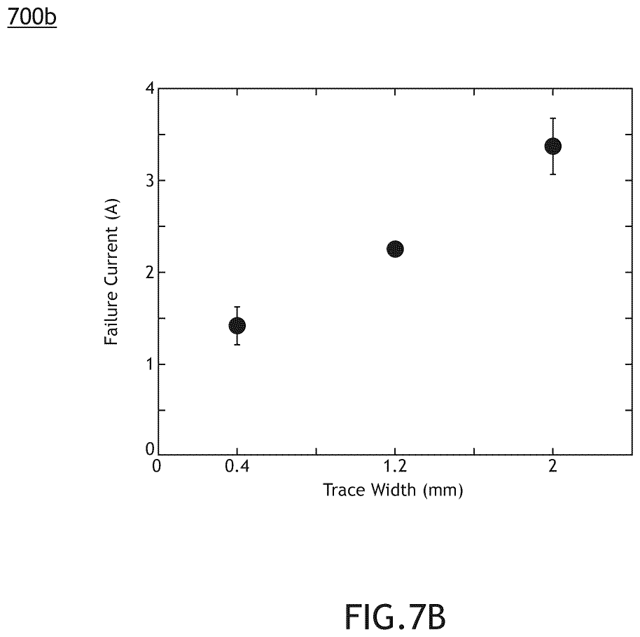

FIGS. 7A-7B illustrate a plot 700a and a plot 700b, in accordance with one or embodiments of the present disclosure. The plot 700a illustrates the failure current in amps (A) as a function of the material thickness in millimeters (mm) of the liquid metal-elastomer composite 110. In this example, the material thickness was varied between 0.25 millimeters, 0.5 millimeters, and 0.75 millimeters with a corresponding failure current of about 1 amps, 1.5 amps, and 1.7 amps, respectively. The plot 700b illustrates the failure current in amps (A) as a function of the trace width in millimeters (mm) of the traces 116. In this example, the trace width was varied between about 0.4 mm, 1.2 mm, and 2 mm with a corresponding failure current of about 1.5 amps, 2.25 amps, and 3.5 amps. The trace width was determined by forming the trace with a select number of lines (1, 3, 5, respectively) using the scoring wheel. The failure current in each of the plot 700a and the plot 700b may refer to the current through the traces 116 at which the traces 116 experience the physical discontinuity due to the electromigration and/or thermal failure.

To systematically investigate the impact of the traces 116 cross-sectional area on electromigration and thermal failure mechanisms, the width and thickness of the traces 116 formed within the liquid metal-elastomer composite 110 were varied. The traces 116 width was controlled by creating multiple adjacent line paths, while the depth of the traces 116 was adjusted by modifying the thickness of the liquid metal-elastomer composite 110. Liquid metal electrodes were deposited at the end of each of the traces 116 and connected to a programmable DC power supply (2260, Keithley). A ramping current was applied in increments 0.25 amps every 30 seconds until the traces 116 was reconfigured and electrical conductivity was lost due to open circuit failure. Notably, the visual appearance of the traces 116 changed from dark gray to a lighter, cloudy gray after failure. The resistance of the traces 116 gradually increased until a significant change occurred, resulting in the loss of electrical conductivity. The current required for circuit reconfiguration was found to increase as the thickness of the liquid metal-elastomer composite 110 increased from 0.25 mm to 0.75 mm and as the traces 116 width increased from one to five adjacent traces. The most substantial change in current, ranging from 1.5 to 3.5 amps, correlated with the increase in the traces 116 width from one to five traces. The ability to tailor the traces 116 area provides new opportunities to control the specific location under which circuit reconfiguration occurs in LM elastomer composites.

As illustrated, the failure current may generally increase with the increase in cross-sectional area due to the increase in the thickness of the liquid metal-elastomer composite 110 and/or the width of the traces 116. The actuator 100 may be designed such that the traces 116 have sufficiently large cross-sectional area and do not experience the physical discontinuity before the electrical networks 105. Additionally, the controller 502 may supply current to the traces 116 at a level below the failure current of the traces 116.

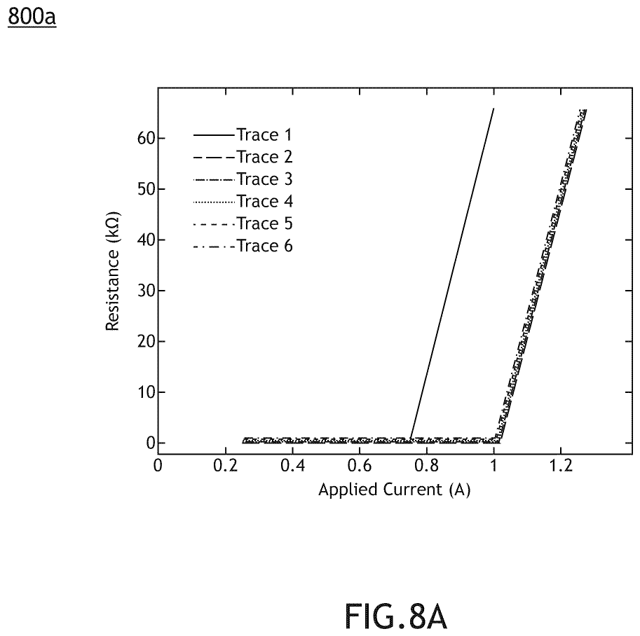

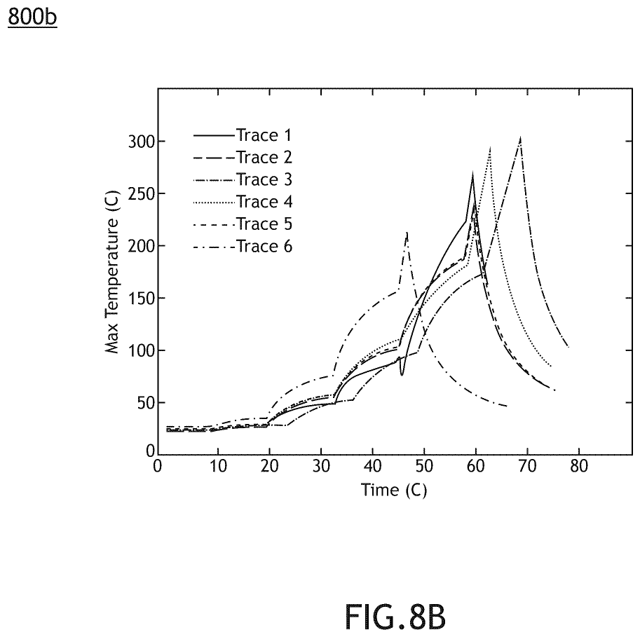

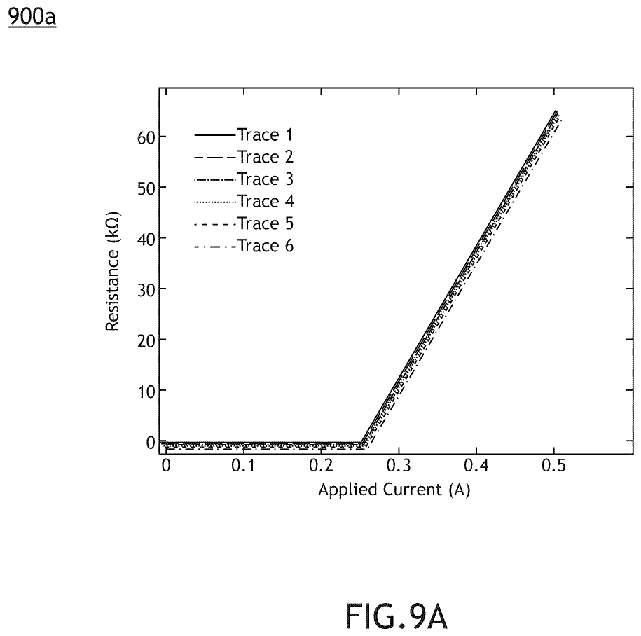

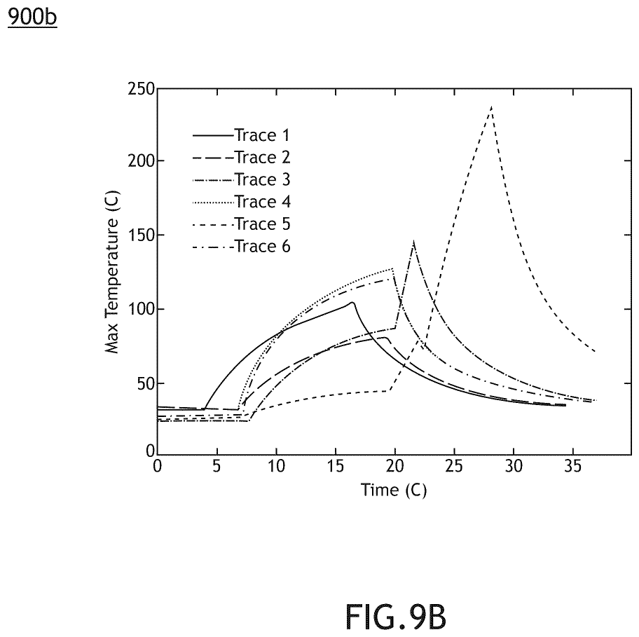

FIGS. 8A-9B illustrate plots of experimental results, in accordance with one or more embodiments of the present disclosure. To demonstrate that the punctures 103 may be electrically detected and subsequently reconfigured, two of the traces 116 (2 mm wide each consisting of five adjacent lines per trace) with a center-to-center spacing of 17 mm in a LM-elastomer composite sample (500 μm thick) were drawn in the liquid metal-elastomer composite 110. Electrodes were patterned on one end of each of the traces 116 to serve as an electrical interface and connected to a programmable DC power supply. Various damage types, such as pressure and the punctures 103, were then applied between the two of the traces 116 to form the electrical networks 105 between the traces 116. The electrical networks 105 were detected by applying a small voltage (1 volt) and measuring current flow to determine if the electrical circuit was complete. Once continuity was established, a ramping current was applied in increments of 0.25 amps every 30 seconds in constant current mode until electromigration and thermal failure occurred, electrically reconfiguring the circuit and causing an open circuit failure at the punctures 103. This process was repeated until a total of six damage and reconfiguration cycles were completed for each damage type per sample. This systematic approach allowed for the reliable evaluation of the electronic skin's performance under various damage scenarios and reconfiguration cycles.

FIGS. 8A-8B illustrate a plot 800a and a plot 800b, in accordance with one or embodiments of the present disclosure. The plots were generated by forming the electrical networks 105 due to pressure damage without the punctures 103 and forming the physical discontinuity in the electrical networks 105. The plot 800a illustrates the resistance (kΩ) between the traces 116 as a function of the applied current (A) when reconfiguring the electrical networks 105. The plot 800b illustrates the maximum temperature of the sample over time as a ramping current was applied in increments 0.25 amps every 30 seconds, until the traces 116 were reconfigured and electrical conductivity was lost due to open circuit failure.

Significant pressure damage was applied to the sample using the scoring wheel attachment on the X-Y plotter, resulting in a single trace electrically connecting the two adjacent of the traces 116. After continuity was established, a current ramp was applied until an open circuit failure occurred, during which the sample's resistance and temperature was measured. As illustrated in the plot 800a, the resistance of the traces 116 gradually increased, until a threshold was reached, leading to the loss of electrical conductivity and simultaneous reconfiguration of the electrical network. The area of the electrical networks 105, represented by a single line, is smaller than that of the traces 116, which consist of five lines each; thus, reconfiguration is anticipated to occur somewhere between the traces 116 along the electrical networks 105. The location of electromigration and thermal failure was confirmed using a thermal camera, with frames captured just before failure occurred. The hottest area directly corresponded to the electrical networks 105 and the location of electromigration and thermal failure. In instances where multiple events of the electrical networks 105 overlap, the thermal camera images reveal the electrical networks 105 and indicated where the circuit was previously reconfigured. Prior to electromigration and thermal failure, the material experiences elevated temperatures exceeding 200° C. at the location of the punctures 103.

FIGS. 9A-9B illustrate a plot 900a and a plot 900b, in accordance with one or embodiments of the present disclosure. The plots were generated by forming the electrical networks 105 with the punctures 103 and forming the physical discontinuity in the electrical networks 105. The plot 900a illustrates the resistance (kΩ) between the traces 116 as a function of the applied current (A) when reconfiguring the electrical networks 105. The plot 900b illustrates the maximum temperature of the sample over time as a ramping current was applied in increments 0.25 amps every 30 seconds, until the traces 116 were reconfigured and electrical conductivity was lost due to open circuit failure.

The punctures 103 were applied to the sample using a precision knife, which cut between the traces 116. After continuity was established, a current ramp was applied until an open circuit failure occurred, during which the sample's resistance and temperature was measured. The resistance of the traces 116 gradually increased, until a threshold was reached, leading to the loss of electrical conductivity and the simultaneous reconfiguration of the electrical networks 05. The area of the punctures 103, represented by a single cut, is smaller and involves a different mechanism of formation of the electrical networks 105 compared to the traces 116, which consist of five lines formed through pressure application. The location of electromigration and thermal failure was confirmed using thermal camera, with frames captured just before failure occurred in the area of the punctures 103. Prior to electromigration and thermal failure, the material experienced elevated temperatures exceeding 100° C. at the site of the punctures 103.

The lower failure currents for the punctures 103 in the plot 900a as compared to sintering due to the pressure in the plot 800a may be due to the more localized nature of the punctures 103 resulting in fewer of the liquid metal microdroplets 114 being ruptured. Conversely, sintering involves more pressure damage resulting in more of the liquid metal microdroplets 114 being ruptured. The lower failure current may correspond to a higher initial resistance measured between the traces 116. This indicates that the controller 502 may detect the type of damage causing the electrical networks 105 based on the resistance between the traces 116.

In response to detecting the formation of the electrical networks 105, the controller 502 may be configured to characterize the electrical networks 105 as being formed by the punctures 103 or by the pressure damage based on the resistance between the traces 116. The pressure damage may not require the melting of the thermoplastic elastomer layer 104 but may require forming the physical discontinuity in the electrical networks 105.

The controller 502 may be configured to cause the actuator 100 to form the physical discontinuity along the electrical networks 105 without causing the electrical networks 105 to locally heat the punctures 103 in response to characterizing the electrical networks 105 as being formed from the pressure damage. For example, if the controller 502 detects the electrical networks 105 were formed from the pressure damage and not the punctures 103, the controller 502 may supply the current at or above the electromigration threshold without heating the thermoplastic elastomer layer 104 above the melting temperature using the current below the electromigration threshold (e.g., the controller 502 may perform the step 660 without performing the step 650). Performing the electromigration without the melting may be advantageous to more rapidly repair the actuator 100.

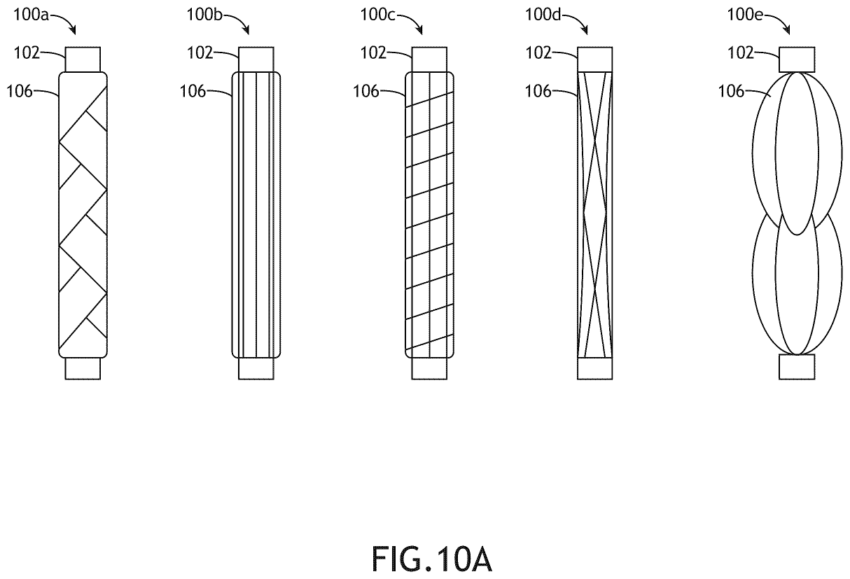

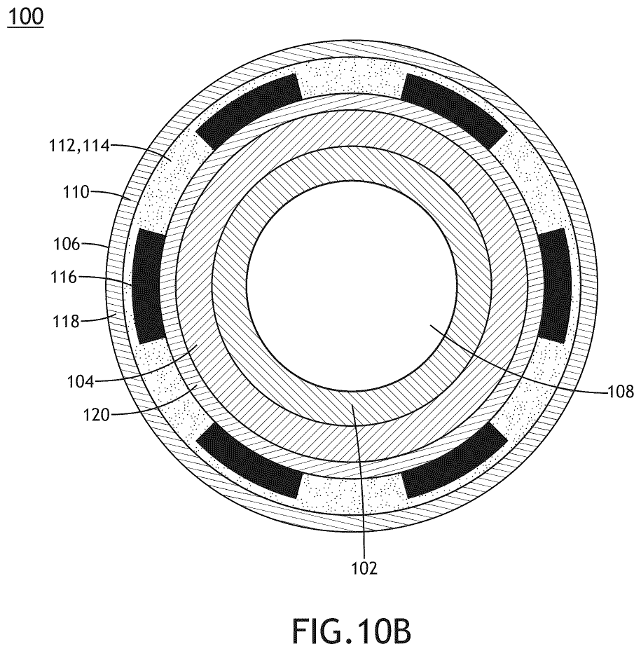

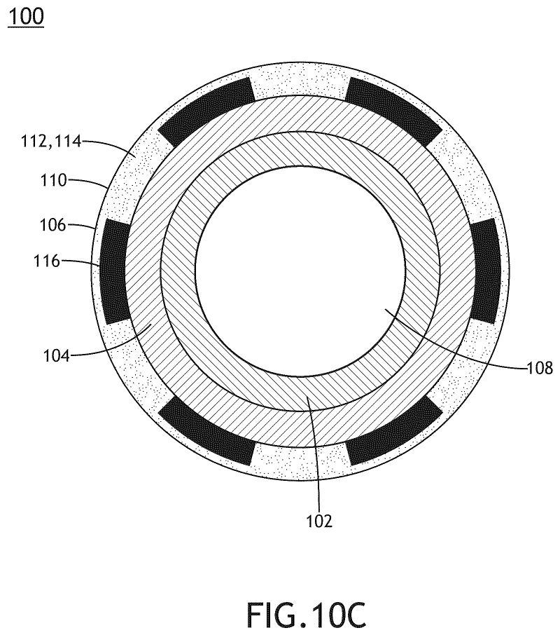

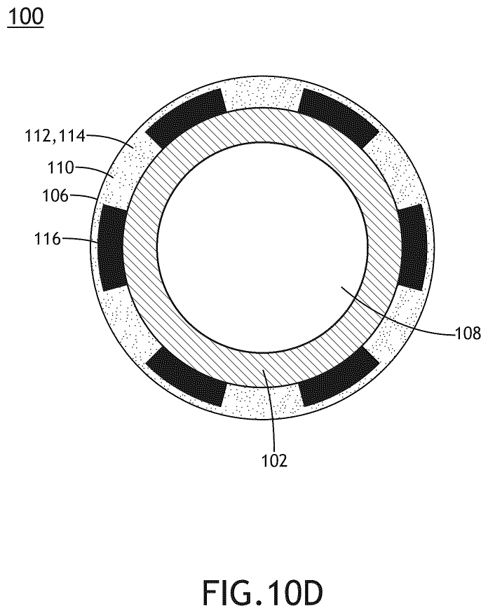

FIGS. 10A-10D illustrate the actuator 100, in accordance with one or more embodiments of the present disclosure. The actuator 100 may include one or more layers or components thereof, such as, but not limited to, the actuation layer 102, the thermoplastic elastomer layer 104, the damage detection layer 106, one of the bladders 108, the liquid metal-elastomer composite 110, the elastomer medium 112, the liquid metal microdroplets 114, the traces 116, the elastomer substrate 118, the elastomer cover 120, and/or the like. The discussion of said layers and/or components thereof is incorporated herein by reference in the entirety.

Although the actuation layer 102 is described as a top layer, the actuation layer 102 is described as including multiple of the bladders 108, and/or the thermoplastic elastomer layer 104 and/or the damage detection layer 106 are described as being planar, this is not intended to be limiting.

The actuation layer 102 may be a core layer of the actuator 100. For example, the actuation layer 102 may be radially inwards of the thermoplastic elastomer layer 104 and/or the damage detection layer 106. The actuation layer 102 may be tubular. The actuation layer 102 may define one or more of the bladders 108. For example, the actuation layer 102 may define one of the bladders 108. The bladder 108 may be inflatable. The actuation layer 102 may be extensible with the inflation of the bladder 108.

The thermoplastic elastomer layer 104 and/or the damage detection layer 106 may be inextensible such that the actuator 100 is configured to actuate with the inflation of the bladder 108. The thermoplastic elastomer layer 104 and/or the damage detection layer 106 may be disposed radially outwards of the actuation layer 102. The thermoplastic elastomer layer 104 and/or the damage detection layer 106 may be a strain limiting sleeve disposed radially outwards of the actuation layer 102. The actuator 100 may actuate by overpressure and/or underpressure of the fluid 101 inflating the bladder 108. The actuator 100 may bend, extend, and/or contract with the actuation. The actuator 100 may bend, extend, and/or contract depending on the configuration of the thermoplastic elastomer layer 104 and/or the damage detection layer 106 and/or the weave of the thermoplastic elastomer layer 104 and/or the damage detection layer 106.

The thermoplastic elastomer layer 104 and/or the damage detection layer 106 may be wrapped around the actuation layer 102. The thermoplastic elastomer layer 104 and/or the damage detection layer 106 may be wrapped with any suitable weave and/or braid. The weave may control the configuration of the artificial muscle. For example, the actuator 100 may include any suitable woven configuration of artificial muscle such as, but not limited to, a McKibben actuator 100a, a pleated muscle 100b, a Yarlott netted muscle 100c, a Paynter hyperboloid muscle 100d, a Robotic Muscle Actuator 100e (ROMAC), or the like. The stiffness of the thermoplastic elastomer material may cause the thermoplastic elastomer layer 104 to act as fibers woven which are inextensible and/or which are woven according to the configuration.

The damage detection layer 106 may include any configuration of the liquid metal-elastomer composite 110 which is or is not encapsulated by the elastomer substrate 118 and/or the elastomer cover 120. The actuator 100 may include a configuration with the thermoplastic elastomer layer 104 and the damage detection layer 106 or may include a configuration with the damage detection layer 106 where the elastomer medium 112 of the liquid metal-elastomer composite 110 is the thermoplastic elastomer.

The traces 116 may include any suitable orientation. For example, the traces 116 may be oriented along the weave and/or along the length of the actuator 100. It is contemplated that the traces 116 may be oriented along the weave by being formed along the liquid metal-elastomer composite 110 of the damage detection layer 106 before the damage detection layer 106 is woven around the actuator layer 102 and/or the thermoplastic elastomer layer 104. It is contemplated that the traces 116 may be oriented length of the actuator 100 by the damage detection layer 106 being woven around the actuator layer 102 and/or the thermoplastic elastomer layer 104 before the traces 116 are formed by the mechanical sintering along the length of the actuator 100.

Referring generally again to the figures. The actuator 100 may autonomously detect and repair the punctures 103, restoring the functionality of the actuation layer 102 without manual intervention. The thermoplastic elastomer layer 104 and the damage detection layer 106 may enhance the resilience and performance of the actuator 100, enabling the adoption of the actuator 100 in various applications, particularly in dynamic and unpredictable environments.

The actuator 100 may enhance the resilience and functionality of soft materials and may pave the way for advanced applications in soft robotics and wearable technologies, where adaptive and autonomous systems are essential for continuous operation in dynamic and unstructured environments. The punctures 103 may be a common concern in soft robotics, particularly when the soft materials and artificial muscles encounter sharp objects or rough surfaces during operation. Addressing the vulnerability of the actuator 100 to the punctures 103 through effective detection and self-healing mechanisms may be beneficial for ensuring the reliability and longevity of soft robotic systems, as pressure or fluid leakage resulting from the punctures 103 can lead to reduced performance and unexpected failures. This systems-level integration of active damage detection and autonomous self-repair can be seamlessly incorporated into a wide range of soft, flexible, or rigid materials without increasing mechanical stiffness. As a result, this technology can support various emerging applications, from bio-inspired soft robotics to wearable computing.

The self-healing of the actuator 100 was experimentally validated by the following procedure. The actuator 100 was pressurized with dyed water and punctured using a precision knife while under pressure. The punctures 103 damaged both the damage detection layer 106 and the thermoplastic elastomer layer 104, causing the dyed water to leak out of the actuator 100 and cause continuity between the three of the traces 116. After depressurizing the actuator 100, a current of 0.5 amps was applied between the two of traces 116 to locally increase the temperature to melt the thermoplastic elastomer layer 104 and seal the puncture. As detected in thermal images, the surface temperature of the liquid metal-elastomer composite 110 reached over 210° C. After approximately 2 minutes, the current was increased until electromigration and thermal failure occurred reconfiguring the electrical networks 105. The actuator 100 was then pressurized again, and no water leaked from the location of the puncture indicating the actuator 100 was successfully self-healed without any manual intervention or external healing mechanisms. To fully reset the damage detection layer 106, a current ramp was applied to the second circuit (between the traces 116) until electromigration and thermal failure occurred, effectively reconfiguring the electrical network to its initial state.

It is noted that insufficient strain is applied to the liquid metal-elastomer composite 110 during the actuation by the actuation layer 102, such that the actuation of the actuator 100 does not cause the formation of the electrical networks 105 between the traces 116.

Notably, the top of the actuation layer 102 is not repaired with the localized Joule heating and self-healing of the thermoplastic elastomer layer 104. It is contemplated that repairing the punctures 103 through the top of the actuation layer 102 may require a different method, such as manual repair using the solvent.

It is contemplated that heating the thermoplastic elastomer layer 104 via the electrical networks 105 is less likely to cause delamination between the layers of the actuator 100 and/or clogging of the bladders 108 due to the localized Joule heating, as opposed to heating across the entirety of the thermoplastic elastomer layer 104.

It is contemplated that the aspect ratio of the liquid metal microdroplets 114 may impact the Joule heating and/or electromigration using the electrical networks 105. For example, the aspect ratio may change the heating rate during Joule heating and/or change the electromigration threshold. For example, the electrical networks 105 formed perpendicular to the elongated microdroplets may have a lower electromigration threshold compared to the being formed parallel to the elongated microdroplets.

It is contemplated that the traces 116 may function as touch sensors. The traces 116 may serve the function of the touch sensor in combination with detecting the formation of the electrical networks 105. For example, the traces 116 may initially serve as touch sensors by functioning as a capacitive sensor which may detect when the actuator 100 is touching an object. The controller 502 may monitor the change in capacitance as a function of pressure. The traces 116 may include any suitable arrangement to enable forming the touch sensor. For example, the traces 116 may be configured as an in-place capacitor, such as the interdigitated combs, or the like. As the traces 116 separate or move together due to the pressure, the controller 502 may measure the change in capacitance. It is further contemplated that the actuator 100 may include a separate touch sensor within one or more of the layers.

The actuator 100 may include various fibers and the like, as is known in the art. For example, the actuation layer 102 may include the fibers. The fibers may structurally reinforce the actuation layer 102.

In the case of a control algorithm, one or more program instructions or methods may be configured to operate via proportional control, feedback control, feedforward control, integral control, proportional-derivative (PD) control, proportional-integral (PI) control, proportional-integral-derivative (PID) control, or the like.

The processors may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the processors may include any device configured to execute algorithms and/or instructions (e.g., program instructions stored in memory). In one embodiment, the processors may be embodied as a desktop computer, mainframe computer system, workstation, image computer, parallel processor, networked computer, or any other computer system, as described throughout the present disclosure

The memory may include any storage medium known in the art suitable for storing program instructions executable by the associated one or more processors. For example, the memory may include a non-transitory memory medium. By way of another example, the memory may include, but is not limited to, a read-only memory (ROM), a random-access memory (RAM), a magnetic or optical memory device (e.g., disk), a magnetic tape, a solid-state drive and the like. It is further noted that memory may be housed in a common controller housing with the processors. In one embodiment, the memory may be located remotely with respect to the physical location of the processors and controller. For instance, the processors may access a remote memory (e.g., server), accessible through a network (e.g., internet, intranet and the like).

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” “temporarily,” or for some period of time. For example, the memory may be random access memory (RAM), and the results may not necessarily persist indefinitely in the memory.

It is further contemplated that each of the embodiments of the methods described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mixable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An actuator comprising:
an actuation layer defining one or more bladders, wherein the actuation layer is extensible by inflation of the one or more bladders;
a thermoplastic elastomer layer; and
a damage detection layer, wherein at least one of the thermoplastic elastomer layer or the damage detection layer is inextensible such that the actuator is configured to actuate with the inflation of the one or more bladders, wherein the damage detection layer comprises a liquid metal-elastomer composite, wherein the liquid metal-elastomer composite comprises an elastomer medium, a plurality of liquid metal microdroplets, and a plurality of traces, wherein the plurality of liquid metal microdroplets are dispersed within the elastomer medium, wherein the plurality of traces are embedded within the elastomer medium, wherein the elastomer medium is a dielectric, wherein the plurality of liquid metal microdroplets and the plurality of traces are conductive.

2. The actuator of claim 1, wherein the thermoplastic elastomer layer is disposed between the actuation layer and the damage detection layer.

3. The actuator of claim 1, wherein the thermoplastic elastomer layer comprises at least one of a thermoplastic polyamide elastomer, a thermoplastic copolyester elastomer, a thermoplastic polyolefin elastomer, a thermoplastic polystyrene elastomer, a thermoplastic polyurethane elastomer, or a thermoplastic vulcanizate elastomer.

4. The actuator of claim 1, wherein the plurality of liquid metal microdroplets and the plurality of traces comprise a gallium alloy.

5. The actuator of claim 1, wherein a median size of the plurality of liquid metal microdroplets is on an order of single digit micrometers, tens of micrometers, or hundreds of micrometers, wherein a volume loading of the plurality of liquid metal microdroplets in the liquid metal-elastomer composite is between 1% and 80% by volume.

6. The actuator of claim 1, wherein the plurality of liquid metal microdroplets are at least one of a liquid phase or a multi-phase inclusion.

7. The actuator of claim 1, wherein the plurality of liquid metal microdroplets are at least one of spherical or ellipsoidal.

8. The actuator of claim 7, wherein the plurality of liquid metal microdroplets are ellipsoidal, wherein an aspect ratio of the plurality of liquid metal microdroplets is between 1 and 30, wherein a largest principal diameter of the plurality of liquid metal microdroplets is oriented along a length of the actuator.

9. The actuator of claim 1, wherein a thickness of the liquid metal-elastomer composite is between 0.05 millimeters and 2 millimeters, wherein a width of the plurality of traces is between 0.25 millimeters and 5 millimeters, wherein the plurality of traces are arranged with a trace-to-trace spacing of at least 0.25 millimeters.

10. The actuator of claim 1, wherein the elastomer medium comprises a thermoset elastomer.

11. The actuator of claim 10, wherein the thermoset elastomer comprises at least one of a silicone elastomer, a polyurethane, a polyvinyl siloxane, a butyl rubber, a fluorosilicate, a styrene butadiene rubber, an acrylonitrile, or a fluoropolymer.

12. The actuator of claim 1, wherein the plurality of traces are oriented along a length of the actuator.

13. The actuator of claim 1, wherein the plurality of traces comprise interdigitated combs.

14. The actuator of claim 1, wherein the damage detection layer comprises an elastomer substrate and an elastomer cover, wherein the elastomer cover is disposed between and bonded to the thermoplastic elastomer layer and the liquid metal-elastomer composite, wherein the liquid metal-elastomer composite is disposed between and bonded to the elastomer cover and the elastomer substrate.

15. The actuator of claim 1, wherein the thermoplastic elastomer layer is bonded to the liquid metal-elastomer composite.

16. The actuator of claim 1, wherein the actuator is configured to receive a puncture through the damage detection layer and the thermoplastic elastomer layer, wherein the puncture is configured to form an electrical network from the plurality of liquid metal microdroplets, wherein the electrical network electrically connects between adjacent traces of the plurality of traces, wherein the electrical network is configured to locally heat the puncture to melt the thermoplastic elastomer layer and seal the puncture, wherein the actuator is configured to form a physical discontinuity along the electrical network.

17. The actuator of claim 1, wherein the actuation of the actuator is at least one of bending, extending, or contracting.

18. The actuator of claim 1, wherein the actuation layer defines a plurality of bladders, wherein at least one of the thermoplastic elastomer layer or the damage detection layer is planar.

19. The actuator of claim 1, wherein the actuation layer is a core layer of the actuator, wherein at least one of the thermoplastic elastomer layer or the damage detection layer is wrapped around the actuation layer.

20. A system comprising:
an actuator comprising:
an actuation layer defining a one or more bladders, wherein the actuation layer is extensible by inflation of the one or more bladders;
a thermoplastic elastomer layer; and
a damage detection layer, wherein at least one of the thermoplastic elastomer layer or the damage detection layer is inextensible such that the actuator is configured to actuate with the inflation of the one or more bladders, wherein the damage detection layer comprises a liquid metal-elastomer composite, wherein the liquid metal-elastomer composite comprises an elastomer medium, a plurality of liquid metal microdroplets, and a plurality of traces, wherein the plurality of liquid metal microdroplets are dispersed within the elastomer medium, wherein the plurality of traces are embedded within the elastomer medium, wherein the elastomer medium is a dielectric, wherein the plurality of liquid metal microdroplets and the plurality of traces are conductive;
wherein the actuator is configured to receive a puncture through the damage detection layer and the thermoplastic elastomer layer, wherein the puncture is configured to form an electrical network from the plurality of liquid metal microdroplets, wherein the electrical network electrically connects between adjacent traces of the plurality of traces;
a pump, wherein the pump is fluidically coupled to the actuation layer by which the one or more bladders are configured to receive a fluid; and
a controller, wherein the controller is connected to the plurality of traces, wherein the controller comprises one or more processors configured to execute program instructions maintained on a memory causing the one or more processors to:
control actuation of the actuator by selectively causing the pump to pump the fluid;
detect the puncture and the electrical network by monitoring a resistance between the plurality of traces;
cause the electrical network to locally heat the puncture to melt the thermoplastic elastomer layer and seal the puncture; and
cause the actuator to form a physical discontinuity along the electrical network.

21. The system of claim 20, wherein the controller is configured to supply current to the plurality of traces to locally heat the puncture using an open-loop control.

22. The system of claim 20, wherein the controller is configured to supply current to the plurality of traces to locally heat the puncture using a closed-loop control, wherein the closed-loop control comprises measuring a temperature of the thermoplastic elastomer layer based on the resistance between the plurality of traces.

23. The system of claim 20, wherein the controller is configured to supply a ramping current or step increasing current to the plurality of traces causing the actuator to form the physical discontinuity along the electrical network.

24. The system of claim 20, wherein the controller is configured to separately characterize the electrical network as being formed from the puncture or from a pressure damage based on the resistance between the plurality of traces.

25. The system of claim 24, wherein the controller is configured to cause the actuator to form the physical discontinuity along the electrical network without causing the electrical network to locally heat the puncture in response to characterizing the electrical network as being formed from the pressure damage.

26. An actuator comprising:
an actuation layer defining one or more bladders, wherein the actuation layer is extensible by inflation of the one or more bladders; and
a damage detection layer, wherein the damage detection layer is inextensible such that the actuator is configured to actuate with the inflation of the one or more bladders, wherein the damage detection layer is bonded to the actuation layer, wherein the damage detection layer comprises a liquid metal-elastomer composite, wherein the liquid metal-elastomer composite comprises an elastomer medium, a plurality of liquid metal microdroplets, and a plurality of traces, wherein the plurality of liquid metal microdroplets are dispersed within the elastomer medium, wherein the plurality of traces are embedded within the elastomer medium, wherein the elastomer medium is a dielectric, wherein the plurality of liquid metal microdroplets and the plurality of traces are conductive, wherein the elastomer medium is a thermoplastic elastomer.
